(19) United States
(12) Patent Application Publication
(10) Pub. No.: US 2026/0044581 A1
(43) Pub. Date: Feb. 12, 2026

(54) MEDIA RIGHTS PLATFORM SYSTEMS AND METHODS

(71) Applicant: MUSIC IP HOLDINGS, INC., Nashville, TN (US)

(72) Inventor: Daniel A. Drolet, SR., Charleston, SC (US)

(21) Appl. No.: 19/360,489

(22) Filed: Oct. 16, 2025

Related U.S. Application Data
(63) Continuation of application No. PCT/US2025/037087, filed on Jul. 10, 2025.
(60) Provisional application No. 63/669,665, filed on Jul. 10, 2024.

(51) Int. Cl. G06F 21/10; G10H 1/00

(52) U.S. Cl. CPC G06F 21/1078; G10H 1/0025; G10H 2210/036; G10H 2210/071; G10H 2210/076; G10H 2210/105; G10H 2210/111; G10H 2210/576; G10H 2240/121; G10H 2240/175

(57) ABSTRACT

A system may receive a request to transform predetermined music content using generative artificial intelligence, wherein the predetermined music content is protected by a copyright and is digitally controlled by a cloud-based authorization server. A system may receive a user request to create a derivative work using the generative artificial intelligence, wherein the request includes a prompt from the user to cause the generative artificial intelligence to create the derivative work as a function of the predetermined music content and a user specific theme for the derivative work. A system may model an owner of the copyright with an AI model and approve creation of the derivative work in response to the modeling predicting that the owner would approve the request. A system may create the derivative work using the generative artificial intelligence and may mark the work with a digital watermark for tracking use of the derivative work.

### CROSS-REFERENCE TO RELATED APPLICATION

This application is a continuation of International Application number PCT/US2025/037087, filed Jul. 10, 2025, which claims the benefit of U.S. Provisional Patent Application Ser. No. 63/669,665, filed Jul. 10, 2024, entitled Media Rights Platform Systems and Methods, which are hereby incorporated by reference in their entirety as if fully set forth herein.

### FIELD

The present disclosure generally relates to a media rights management platform including copyright management in conjunction with an artificial intelligence-generated music-derivative works system and various large language model engines to provide access to multiple users for those protected media rights.

### BACKGROUND

The realm of artificial intelligence (AI) has witnessed substantial progress in recent years, with its applications permeating various sectors, including but not limited to healthcare, finance, transportation, and entertainment. A particular application that has been gaining significant traction is the utilization of AI in the domain of music creation. This technology, often referred to as algorithmic composition, leverages AI algorithms to compose music without the need for human intervention. However, the integration of AI in music creation also introduces several legal and ethical dilemmas, particularly concerning copyright law.

Copyright law safeguards the rights of creators by providing them with exclusive rights to their works, which includes the right to reproduce, distribute, perform, and create derivative works based on their original creations. In the context of AI-generated music, questions surface regarding the ownership of the copyright to the music created by AI, and whether the use of copyrighted music to train AI algorithms constitutes copyright infringement. The issue of copyright infringement becomes especially relevant in the case of AI-generated derivative works.

Derivative works are creations that are based on one or more pre-existing works. In the case of AI-generated music, derivative works can be created by using AI algorithms to analyze and learn from copyrighted music, and then generate new music based on the learned patterns and structures. This process can potentially infringe on the rights of the original copyright holders, as it involves the reproduction and transformation of their works without their permission. Moreover, the application of AI in music creation also raises issues related to the fair use doctrine.

Fair use is a legal doctrine that permits limited use of copyrighted material without the permission of the copyright holder, under certain circumstances. In the context of AI-generated music, it is unclear whether the use of copyrighted music to train AI algorithms falls under the scope of fair use. This uncertainty creates a legal grey area that can potentially lead to disputes and litigation. In addition to these legal and ethical issues, there are also technical challenges associated with the use of AI in music creation. One of the main challenges is the quality of the AI-generated music.

While AI algorithms are capable of learning and mimicking the patterns and structures in music, they often lack the creativity and emotional depth that characterize human-composed music. This can result in AI-generated music that is technically correct but lacks the emotional resonance and artistic value of human-composed music. Another challenge is the lack of transparency and interpretability in AI algorithms.

AI algorithms, particularly those based on deep learning, are often described as “black boxes” due to their complex and opaque nature. This lack of transparency makes it difficult to understand how the AI algorithms generate music, which can lead to issues related to accountability and trust.

Considering these challenges and issues, there is a need for improvements in the field of AI-generated music. These improvements should aim to address the legal and ethical issues associated with copyright infringement and fair use, enhance the quality of the AI-generated music, and increase the transparency and interpretability of the AI algorithms. By addressing these issues, we can harness the potential of AI in music creation, while ensuring respect for the rights of artists and copyright holders and maintaining the artistic integrity of music. Improvements are desired to overcome shortcomings of existing implementations.

### SUMMARY

In embodiments, the techniques described herein relate to a method including: receiving a request to transform predetermined music content using generative artificial intelligence, wherein the predetermined music content is protected by a copyright and is digitally controlled by a cloud-based authorization server; receiving a user request to create a derivative work using the generative artificial intelligence, wherein the request includes a prompt from the user to cause the generative artificial intelligence to create the derivative work as a function of the predetermined music content and a user specific theme for the derivative work; modeling an owner of the copyright with an AI model; approving creation of the derivative work in response to the modeling predicting that the owner would approve the request; creating the derivative work using the generative artificial intelligence; and marking the work with a digital watermark for tracking use of the derivative work.

In embodiments, the techniques described herein relate to a method, wherein the generative artificial intelligence includes at least one of large language models (LLMs), transformer networks, generative adversarial networks (GANs), variational autoencoders (VAEs), recurrent neural networks (RNNs), and diffusion models.

In embodiments, the techniques described herein relate to a method, wherein the digital watermark includes at least one of spread spectrum watermarking, quantization-based watermarking, transform domain watermarking, and perceptual watermarking.

In embodiments, the techniques described herein relate to a method, wherein modeling the owner of the copyright includes analyzing historical licensing decisions, legal precedents, and copyright holder behavior patterns.

In embodiments, the techniques described herein relate to a method, further including preprocessing the predetermined music content to extract harmonic structure, rhythmic patterns, melodic contours, and textural elements.

In embodiments, the techniques described herein relate to a method, wherein the user specific theme includes at least one of genre specification, mood requirements, instrumentation preferences, and temporal constraints.

In embodiments, the techniques described herein relate to a method, further including utilizing Interactive Evolutionary Algorithms (IEAs) in combination with neural networks to create the derivative work.

In embodiments, the techniques described herein relate to a method, further including integrating with digital audio workstations (DAWs) through standardized interface protocols including MIDI, OSC, and VST plugin architectures.

In embodiments, the techniques described herein relate to a method, further including performing natural language processing on the user request to extract creative parameters and constraints.

In embodiments, the techniques described herein relate to a method, further including analyzing licensing agreements to extract relevant terms and conditions for approval prediction in the modeling.

In embodiments, the techniques described herein relate to a method, further including generating an intellectual property rights violations report when unauthorized derivative work creation is detected.

In embodiments, the techniques described herein relate to a method, further including performing sentiment analysis on the user specific theme to determine emotional content and mood requirements.

In embodiments, the techniques described herein relate to a method, further including cross-referencing the derivative work with existing copyrighted material to assess potential infringement risks.

In embodiments, the techniques described herein relate to a method, further including generating real-time feedback regarding copyright compliance during creation of the derivative work.

In embodiments, the techniques described herein relate to a method, further including maintaining a database of watermark signatures corresponding to specific derivative works and their associated licensing terms.

In embodiments, the techniques described herein relate to a method, further including applying signal processing techniques including Fourier transforms, wavelet analysis, and spectral analysis to the predetermined music content.

In embodiments, the techniques described herein relate to a method, further including determining a risk profile based on the user request and escalating high-risk assessments to human review.

In embodiments, the techniques described herein relate to a method, further including generating licensing proposals automatically when copyright violations are detected.

In embodiments, the techniques described herein relate to a method, further including dynamically adjusting approval criteria based on market factors, demand patterns, and seasonality.

In embodiments, the techniques described herein relate to a system including: a cloud-based authorization server configured to digitally control predetermined music content protected by copyright; a generative artificial intelligence system configured to create derivative works from the predetermined music content; an AI modeling system configured to model copyright owners and predict approval likelihood for derivative work requests; a digital watermarking system configured to embed, detect, and track digital watermarks within derivative works; and one or more processors configured to execute instructions to: receive a request to transform the predetermined music content using the generative artificial intelligence system; receive a user request to create a derivative work including a prompt specifying a user specific theme; model an owner of the copyright using the AI modeling system; approve creation of the derivative work in response to predicted owner approval; create the derivative work using the generative artificial intelligence system; and mark the derivative work with a digital watermark using the digital watermarking system.

In embodiments, the techniques described herein relate to a method for AI media origination identification including: collecting media files from original artists and generative artificial intelligence companies; scanning bytes of the media files using a digital fingerprinting engine to identify generative AI identification strings and signatures; performing pattern matching to identify GAI-MC fingerprints within the media files; comparing identified fingerprints against a database of known AI-generated content signatures; determining origination source of the media files based on analysis of the fingerprints; generating intellectual property rights violations reports when unauthorized AI-generated content is detected; cross-referencing detected material with intellectual property licenses in force; and triggering automated response actions including licensing proposals and cease and desist notifications.

In embodiments, the techniques described herein relate to a method, wherein the digital fingerprinting engine is configured to detect watermarks embedded by various AI generation systems.

In embodiments, the techniques described herein relate to a method, wherein the GAI-MC fingerprints include unique byte sequences generated by specific AI model architectures.

In embodiments, the techniques described herein relate to a method, further including analyzing metadata associated with the media files to identify AI generation indicators.

In embodiments, the techniques described herein relate to a method, further including performing spectral analysis to identify characteristic patterns of AI-generated audio content.

In embodiments, the techniques described herein relate to a method, further including maintaining a continuously updated database of AI generation signatures from emerging AI systems.

In embodiments, the techniques described herein relate to a method, further including calculating confidence scores for AI origination determinations based on multiple identification criteria.

In embodiments, the techniques described herein relate to a method, further including tracking distribution patterns of identified AI-generated content across multiple platforms.

In embodiments, the techniques described herein relate to a method, further including generating alerts when new AI generation techniques are detected that lack corresponding identification signatures.

In embodiments, the techniques described herein relate to a method, further including performing real-time monitoring of content streams from Internet sources to identify newly uploaded AI-generated material.

In embodiments, the techniques described herein relate to a method, further including analyzing harmonic and rhythmic patterns characteristic of specific AI generation algorithms.

In embodiments, the techniques described herein relate to a method, further including maintaining version control tracking for AI-generated content and its derivative works.

In embodiments, the techniques described herein relate to a method, further including performing statistical analysis of audio characteristics to distinguish AI-generated from human-created content.

In embodiments, the techniques described herein relate to a method, further including integrating with content distribution platforms to provide real-time AI origination identification services.

In embodiments, the techniques described herein relate to a method, further including generating forensic reports suitable for legal proceedings regarding AI content origination disputes.

In embodiments, the techniques described herein relate to a method, further including performing batch processing of large media archives to identify previously undetected AI-generated content.

In embodiments, the techniques described herein relate to a method, further including calculating similarity scores between analyzed content and known AI training datasets.

In embodiments, the techniques described herein relate to a method, further including maintaining audit trails of all AI origination identification decisions and confidence levels.

In embodiments, the techniques described herein relate to a method, further including providing API access for third-party applications to utilize AI origination identification services.

In embodiments, the techniques described herein relate to a system for AI media origination identification including: a content collection module configured to gather media files from original artists and generative artificial intelligence companies; a digital fingerprinting engine configured to scan bytes of media files for generative AI identification strings and signatures; a pattern matching module configured to identify GAI-MC fingerprints within analyzed media files; a signature database configured to store known AI-generated content signatures; a violations reporting module configured to generate intellectual property rights violations reports; and one or more processors configured to execute instructions to: collect media files from multiple sources; perform fingerprint analysis on the collected media files; identify AI origination indicators within the media files; generate violations reports when unauthorized AI-generated content is detected; and trigger automated response actions for detected violations.

In embodiments, the techniques described herein relate to a method for AI powered songwriting tools including: analyzing databases of lyrics and music compositions using a natural language processing engine; determining emotional content and mood of lyrical content using a sentiment analysis module; performing topic modeling using Latent Dirichlet Allocation (LDA) or Non-Negative Matrix Factorization (NMF) to identify thematic patterns; generating lyrical content using recurrent neural networks (RNNs) or transformer architectures; providing real-time feedback mechanisms for artists regarding generated content quality; analyzing chord progressions for musical coherence and originality using harmonic analysis modules; assessing generated melodies for singability, memorability, and distinctiveness using melodic analysis components; integrating with digital audio workstations and songwriting software; and providing contextually appropriate suggestions for creative development.

In embodiments, the techniques described herein relate to a method, further including analyzing rhyme schemes and meter patterns within existing lyrical databases.

In embodiments, the techniques described herein relate to a method, further including generating chord progressions based on harmonic analysis of successful musical compositions.

In embodiments, the techniques described herein relate to a method, further including providing real-time collaboration features for multiple artists working on a same composition.

In embodiments, the techniques described herein relate to a method, further including analyzing musical structure patterns including verse-chorus arrangements and bridge sections.

In embodiments, the techniques described herein relate to a method, further including generating instrumental arrangements based on genre-specific orchestration patterns.

In embodiments, the techniques described herein relate to a method, further including providing style transfer capabilities to adapt compositions to different musical genres.

In embodiments, the techniques described herein relate to a method, further including analyzing vocal range requirements and adjusting melodic content accordingly.

In embodiments, the techniques described herein relate to a method, further including generating backing harmonies and vocal arrangements for lead melodies.

In embodiments, the techniques described herein relate to a method, further including providing automated mixing and mastering suggestions based on genre conventions.

In embodiments, the techniques described herein relate to a method, further including analyzing tempo and rhythm patterns to ensure musical coherence.

In embodiments, the techniques described herein relate to a method, further including generating drum patterns and percussion arrangements tailored to specific musical styles.

In embodiments, the techniques described herein relate to a method, further including providing copyright clearance verification for generated content.

In embodiments, the techniques described herein relate to a method, further including analyzing market trends to suggest commercially viable musical directions.

In embodiments, the techniques described herein relate to a method, further including providing personalized songwriting assistance based on individual artist preferences and historical output.

In embodiments, the techniques described herein relate to a method, further including generating alternative versions of compositions with different emotional tones.

In embodiments, the techniques described herein relate to a method, further including analyzing successful song structures within specific genres to inform composition suggestions.

In embodiments, the techniques described herein relate to a method, further including providing automated lyric translation services for international market adaptation.

In embodiments, the techniques described herein relate to a method, further including generating demo recordings with synthesized instruments and vocals.

In embodiments, the techniques described herein relate to a system for AI powered songwriting tools including: a natural language processing engine configured to analyze databases of lyrics and music compositions; a sentiment analysis module configured to determine emotional content and mood of lyrical content; a topic modeling module configured to identify thematic patterns using machine learning algorithms; a lyric generation module configured to create textual content using neural networks; a harmonic analysis module configured to evaluate chord progressions; a melodic analysis module configured to assess generated melodies; real-time feedback mechanisms configured to provide immediate assessment of generated content; integration interfaces configured to connect with digital audio workstations and songwriting software; and one or more processors configured to execute instructions to: analyze lyrical and musical databases; generate creative content suggestions; provide real-time feedback to artists; and facilitate integration with existing music production workflows.

In embodiments, the techniques described herein relate to a method for model architecture iteration including: evaluating performance of multiple AI generation models using systematic testing methodologies; implementing AB testing frameworks to compare different model configurations and architectures; measuring performance metrics including generation quality scores, copyright compliance rates, user satisfaction ratings, and computational efficiency; analyzing user feedback and engagement patterns to identify model improvement opportunities; implementing continuous learning mechanisms to adapt models based on usage patterns and outcomes; maintaining version control systems for model iterations and performance tracking; performing automated hyperparameter optimization to enhance model performance; conducting comparative analysis between different neural network architectures for music generation; and implementing rollback mechanisms for model versions that demonstrate decreased performance.

In embodiments, the techniques described herein relate to a method, further including implementing ensemble methods combining multiple AI architectures for enhanced generation quality.

In embodiments, the techniques described herein relate to a method, further including performing transfer learning to adapt models trained on one musical genre to other genres.

In embodiments, the techniques described herein relate to a method, further including implementing federated learning approaches to improve models while preserving data privacy.

In embodiments, the techniques described herein relate to a method, further including conducting ablation studies to identify critical model components and their contributions to performance.

In embodiments, the techniques described herein relate to a method, further including implementing progressive training strategies to gradually increase model complexity.

In embodiments, the techniques described herein relate to a method, further including analyzing computational resource requirements for different model architectures.

In embodiments, the techniques described herein relate to a method, further including implementing automated model selection based on specific use case requirements.

In embodiments, the techniques described herein relate to a method, further including conducting cross-validation studies to ensure model generalization across different musical styles.

In embodiments, the techniques described herein relate to a method, further including implementing active learning strategies to identify optimal training data for model improvement.

In embodiments, the techniques described herein relate to a method, further including performing model distillation to create efficient versions of complex architectures.

In embodiments, the techniques described herein relate to a method, further including implementing multi-objective optimization to balance generation quality with computational efficiency.

In embodiments, the techniques described herein relate to a method, further including conducting bias analysis to ensure fair representation across different musical genres and cultural contexts.

In embodiments, the techniques described herein relate to a method, further including implementing reinforcement learning from human feedback to improve model outputs.

In embodiments, the techniques described herein relate to a method, further including performing systematic evaluation of model robustness against adversarial inputs.

In embodiments, the techniques described herein relate to a method, further including implementing distributed training strategies for large-scale model architectures.

In embodiments, the techniques described herein relate to a method, further including conducting longitudinal studies to assess model performance degradation over time.

In embodiments, the techniques described herein relate to a method, further including implementing automated model monitoring and alerting systems for performance anomalies.

In embodiments, the techniques described herein relate to a method, further including performing competitive analysis against state-of-the-art AI generation systems.

In embodiments, the techniques described herein relate to a system for model architecture iteration including: a performance evaluation module configured to assess AI generation model performance using systematic testing methodologies; an A/B testing framework configured to compare different model configurations; a metrics collection system configured to measure generation quality, compliance rates, and user satisfaction; a feedback analysis module configured to analyze user engagement patterns; a continuous learning system configured to adapt models based on usage patterns; a version control system configured to track model iterations and performance; a hyperparameter optimization module configured to enhance model performance automatically; a comparative analysis module configured to evaluate different neural network architectures; and one or more processors configured to execute instructions to: evaluate multiple AI generation models; implement systematic testing and comparison methodologies; collect and analyze performance metrics; adapt models based on feedback and usage patterns; and maintain version control and rollback capabilities.

In embodiments, the techniques described herein relate to a method for developing songwriting suggestions including: analyzing partial compositions to identify musical context and structural patterns; providing contextually appropriate suggestions for chord progressions based on harmonic analysis; generating melodic development suggestions that complement existing musical content; offering lyrical content suggestions that match thematic and emotional requirements; providing structural arrangement suggestions including verse-chorus organization and bridge sections; analyzing musical genre conventions to ensure stylistic consistency; generating instrumentation suggestions based on genre-specific orchestration patterns; providing real-time creative assistance integrated with digital audio workstations; maintaining databases of successful musical compositions for reference and inspiration; and adapting suggestions based on individual artist preferences and historical creative patterns.

In embodiments, the techniques described herein relate to a method, further including analyzing tempo and rhythm patterns to ensure musical coherence in suggestions.

In embodiments, the techniques described herein relate to a method, further including generating suggestions for vocal harmonies and backing arrangements.

In embodiments, the techniques described herein relate to a method, further including providing dynamic range and arrangement suggestions for different song sections.

In embodiments, the techniques described herein relate to a method, further including analyzing market trends to suggest commercially viable musical directions.

In embodiments, the techniques described herein relate to a method, further including generating alternative versions of suggested content with different emotional tones.

In embodiments, the techniques described herein relate to a method, further including providing real-time collaboration features for multiple artists working on a same composition.

In embodiments, the techniques described herein relate to a method, further including analyzing successful song structures within specific genres to inform suggestions.

In embodiments, the techniques described herein relate to a method, further including generating suggestions for transitions between different song sections.

In embodiments, the techniques described herein relate to a method, further including providing automated arrangement suggestions for different instrumental configurations.

In embodiments, the techniques described herein relate to a method, further including analyzing vocal range requirements and adjusting melodic suggestions accordingly.

In embodiments, the techniques described herein relate to a method, further including generating percussion and drum pattern suggestions tailored to specific musical styles.

In embodiments, the techniques described herein relate to a method, further including providing copyright clearance verification for suggested content.

In embodiments, the techniques described herein relate to a method, further including analyzing lyrical themes and suggesting complementary musical elements.

In embodiments, the techniques described herein relate to a method, further including generating suggestions for song endings and climactic sections.

In embodiments, the techniques described herein relate to a method, further including providing personalized suggestion algorithms based on individual artist preferences.

In embodiments, the techniques described herein relate to a method, further including analyzing emotional arc progression within songs to suggest appropriate musical development.

In embodiments, the techniques described herein relate to a method, further including generating suggestions for remix and variation opportunities.

In embodiments, the techniques described herein relate to a method, further including providing real-time feedback on commercial viability of suggested directions.

In embodiments, the techniques described herein relate to a system for developing songwriting suggestions including: a composition analysis module configured to analyze partial compositions and identify musical context; a chord progression suggestion engine configured to provide harmonically appropriate recommendations; a melodic development module configured to generate complementary melodic suggestions; a lyrical content suggestion engine configured to provide thematically appropriate textual content; a structural arrangement module configured to suggest verse-chorus organization and bridge sections; a genre analysis module configured to ensure stylistic consistency; an instrumentation suggestion engine configured to provide orchestration recommendations; a real-time assistance interface configured to integrate with digital audio workstations; a musical database configured to store successful compositions for reference; and one or more processors configured to execute instructions to: analyze partial compositions; generate contextually appropriate suggestions; provide real-time creative assistance; maintain databases of musical references; and adapt suggestions based on individual artist preferences.

In embodiments, the techniques described herein relate to a method for copyright licensing including: interacting with potential licensees through an intelligent chatbot system requesting intellectual property usage rights; operating as an agent or plugin to existing large language model platforms including ChatGPT and Bard; questioning users on usage attributes including commercial versus non-commercial models, timeframe requirements, and geographical scope; determining risk profiles based on gathered information using machine learning algorithms; escalating high-risk assessments to third parties for human assessment and review; generating automated licensing proposals based on usage requirements and risk assessment; maintaining integration with digital watermarking capabilities for compliance monitoring; processing licensing agreements and generating appropriate documentation; tracking license usage and ensuring compliance with agreed terms; and providing real-time licensing status updates to copyright holders and licensees.

In embodiments, the techniques described herein relate to a method, further including analyzing historical licensing data to optimize approval decisions.

In embodiments, the techniques described herein relate to a method, further including generating customized licensing terms based on specific use case requirements.

In embodiments, the techniques described herein relate to a method, further including providing automated renewal notifications for expiring licenses.

In embodiments, the techniques described herein relate to a method, further including integrating with payment processing systems for automatic license fee collection.

In embodiments, the techniques described herein relate to a method, further including maintaining audit trails of all licensing decisions and communications.

In embodiments, the techniques described herein relate to a method, further including generating reports on licensing activity and revenue generation.

In embodiments, the techniques described herein relate to a method, further including providing API access for third-party applications to request licensing services.

In embodiments, the techniques described herein relate to a method, further including analyzing market conditions to suggest competitive licensing rates.

In embodiments, the techniques described herein relate to a method, further including generating cease and desist communications for unauthorized usage.

In embodiments, the techniques described herein relate to a method, further including providing multi-language support for international licensing negotiations.

In embodiments, the techniques described herein relate to a method, further including maintaining databases of licensing precedents and comparable agreements.

In embodiments, the techniques described herein relate to a method, further including generating licensing recommendations based on content similarity analysis.

In embodiments, the techniques described herein relate to a method, further including providing automated dispute resolution mechanisms for licensing conflicts.

In embodiments, the techniques described herein relate to a method, further including analyzing usage patterns to suggest licensing optimization opportunities.

In embodiments, the techniques described herein relate to a method, further including generating compliance monitoring reports for licensed content usage.

In embodiments, the techniques described herein relate to a method, further including providing real-time licensing availability information for content catalogs.

In embodiments, the techniques described herein relate to a method, further including maintaining integration with content distribution platforms for licensing enforcement.

In embodiments, the techniques described herein relate to a method, further including generating licensing performance analytics and success metrics.

In embodiments, the techniques described herein relate to a system for copyright licensing including: an intelligent chatbot system configured to interact with potential licensees requesting intellectual property usage rights; a plugin interface configured to operate with existing large language model platforms; a user questionnaire module configured to collect usage attribute information; a risk assessment engine configured to determine risk profiles using machine learning algorithms; an escalation system configured to route high-risk assessments to human review; a proposal generation module configured to create automated licensing proposals; a digital watermarking integration module configured to ensure compliance monitoring; a licensing agreement processing system configured to generate appropriate documentation; a usage tracking module configured to monitor license compliance; and one or more processors configured to execute instructions to: interact with potential licensees through automated systems; collect usage requirement information; assess risk profiles and generate licensing proposals; process licensing agreements and documentation; track license usage and ensure compliance; and provide real-time status updates to stakeholders.

In embodiments, the techniques described herein relate to a method for generating personalized subscription plans including: performing customer segmentation based on music preferences, listening habits, and demographic information; analyzing usage history and consumption patterns to identify individual user requirements; utilizing dynamic pricing engines to adjust subscription costs based on market factors, demand patterns, and seasonality; generating personalized subscription plans tailored to individual user preferences and usage patterns; creating bundling options that combine multiple services based on user interest profiles; implementing revenue optimization through dynamic pricing strategies considering real-time market conditions; analyzing competitor pricing and market penetration goals to inform pricing decisions; utilizing reinforcement learning techniques to optimize pricing based on conversion rates and customer lifetime value; providing flexible subscription modification options based on changing user requirements; and generating personalized recommendations for subscription upgrades and additional services.

In embodiments, the techniques described herein relate to a method, further including analyzing seasonal usage patterns to suggest temporary subscription modifications.

In embodiments, the techniques described herein relate to a method, further including implementing loyalty programs with personalized rewards based on usage history.

In embodiments, the techniques described herein relate to a method, further including generating family and group subscription plans with shared benefits.

In embodiments, the techniques described herein relate to a method, further including providing trial period optimization based on individual user engagement patterns.

In embodiments, the techniques described herein relate to a method, further including analyzing churn risk and implementing personalized retention strategies.

In embodiments, the techniques described herein relate to a method, further including generating location-based subscription options with regional content preferences.

In embodiments, the techniques described herein relate to a method, further including providing subscription pause and resume options with personalized scheduling.

In embodiments, the techniques described herein relate to a method, further including implementing usage-based billing models for high-consumption users.

In embodiments, the techniques described herein relate to a method, further including generating cross-platform subscription integration with partner services.

In embodiments, the techniques described herein relate to a method, further including analyzing social network connections to suggest collaborative subscription options.

In embodiments, the techniques described herein relate to a method, further including providing personalized content curation as part of subscription packages.

In embodiments, the techniques described herein relate to a method, further including generating subscription gift options with personalized recipient matching.

In embodiments, the techniques described herein relate to a method, further including implementing subscription analytics and usage insights for subscribers.

In embodiments, the techniques described herein relate to a method, further including providing personalized customer support based on subscription tier and usage patterns.

In embodiments, the techniques described herein relate to a method, further including generating subscription recommendations based on life events and changing circumstances.

In embodiments, the techniques described herein relate to a method, further including implementing flexible payment options including cryptocurrency and alternative payment methods.

In embodiments, the techniques described herein relate to a method, further including providing subscription portability across different device platforms and ecosystems.

In embodiments, the techniques described herein relate to a method, further including generating personalized subscription migration paths for users changing service levels.

In embodiments, the techniques described herein relate to a system for generating personalized subscription plans including: a customer segmentation module configured to analyze music preferences, listening habits, and demographic information; a usage analysis engine configured to identify individual user requirements and consumption patterns; a dynamic pricing engine configured to adjust subscription costs based on market factors and demand patterns; a personalization module configured to generate tailored subscription plans based on user preferences; a bundling engine configured to create service combinations based on user interest profiles; a revenue optimization module configured to implement dynamic pricing strategies; a market analysis module configured to analyze competitor pricing and market conditions; a reinforcement learning system configured to optimize pricing based on conversion rates and customer lifetime value; a subscription modification system configured to provide flexible plan changes; and one or more processors configured to execute instructions to: perform customer segmentation and usage analysis; generate personalized subscription plans and bundling options; implement dynamic pricing and revenue optimization strategies; provide flexible subscription modification capabilities; and generate personalized recommendations for service upgrades and additional offerings.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram that illustrates a platform for transforming predetermined content using generative artificial intelligence according to the present disclosure.

### DETAILED DESCRIPTION

Various aspects of the present disclosure may be described with reference to the drawings, wherein like reference numerals are used to refer to like elements throughout. In the following description, for purposes of explanation, numerous specific details are set forth in order to promote a thorough understanding of one or more aspects of the present application. It may be evident in some or all instances, however, that any aspects described below can be practiced without adopting the specific design details described below.

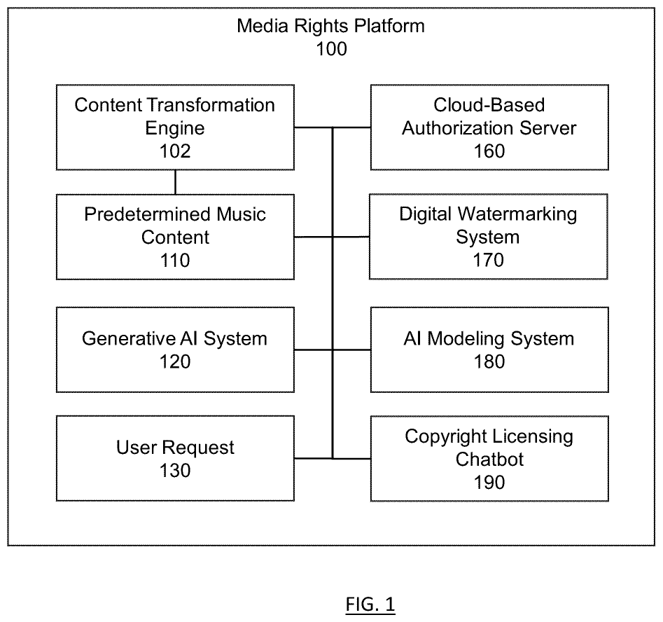

Referring now to FIG. 1, a media rights platform 100 is illustrated in accordance with some embodiments. Platform 100 includes a cloud-based authorization server 160, a content transformation engine 102, a generative artificial intelligence system 120, an AI modeling system 180, and a digital watermarking system 170, among other components. Platform 100 is configured to manage copyright permissions and facilitate creation of AI-generated derivative works while maintaining compliance with intellectual property rights and providing comprehensive tracking and attribution mechanisms.

Cloud-based authorization server 160 is configured to digitally control access to predetermined music content 110, which comprises copyrighted material including musical compositions, audio recordings, video content, textual works, or combinations thereof. Cloud-based authorization server 160 maintains a database of copyright ownership information, licensing terms, and usage permissions for various content items. The server operates independently of specific generative AI models employed by the system, ensuring consistent copyright control regardless of the underlying AI architecture utilized for content generation.

Content transformation engine 102 is configured to process and transform predetermined music content 110 into formats suitable for analysis by the generative artificial intelligence system 120. The transformation engine includes preprocessing modules that extract relevant features from source content, including harmonic structure, rhythmic patterns, melodic contours, and textural elements. The engine may apply various signal processing techniques including Fourier transforms, wavelet analysis, and spectral analysis to prepare content for AI processing while preserving essential musical characteristics.

Generative artificial intelligence system 120 comprises a comprehensive suite of machine learning architectures including large language models (LLMs), transformer networks, generative adversarial networks (GANs), variational autoencoders (VAEs), recurrent neural networks (RNNs), and other deep learning architectures. The system is further configured to integrate diffusion models as additional generative AI components for enhanced content generation capabilities. Each AI architecture within the generative AI system 120 is optimized for specific aspects of music generation, including harmonic progression, melodic development, rhythmic complexity, and textural arrangement.

In some embodiments, the generative AI system 120 utilizes Interactive Evolutionary Algorithms (IEAs) in combination with neural networks to create musical compositions incorporating elements from existing copyrighted works. The IEAs provide a framework for iterative refinement of generated content based on user feedback and predetermined aesthetic criteria. The system maintains compatibility with existing songwriting software and digital audio workstations (DAWs) through standardized interface protocols including MIDI, OSC, and VST plugin architectures.

AI modeling system 180 is configured to determine whether derivative works should be approved for creation based on various factors including content owner preferences, licensing terms, fair use considerations, and potential infringement risks. The system employs machine learning models trained on historical licensing decisions, legal precedents, and copyright holder behavior patterns to predict approval likelihood for specific derivative work requests. AI modeling system 180 includes natural language processing capabilities to analyze licensing agreements and extract relevant terms and conditions.

Digital watermarking system 170 is configured to embed, detect, and track digital watermarks within derivative works created by generative AI system 120. The watermarking system employs various techniques including spread spectrum watermarking, quantization-based watermarking, transform domain watermarking, and perceptual watermarking to ensure robust watermark persistence across different distribution channels and potential tampering attempts. The system maintains a database of watermark signatures corresponding to specific derivative works and their associated licensing terms.

Platform 100 further includes an AI media origination identification system comprising a content collection module configured to gather media files from original artists and generative artificial intelligence companies. The system includes a digital fingerprinting engine configured to scan bytes of media files for generative AI identification strings and signatures. Pattern matching algorithms are employed to identify GAI-MC (Generative AI Music Content) fingerprints within analyzed media files. The system generates intellectual property rights violations reports when unauthorized AI-generated content is detected.

The AI-powered songwriting tools within platform 100 include a natural language processing engine configured to analyze databases of lyrics and music compositions. A sentiment analysis module is configured to determine emotional content and mood of lyrical content using advanced machine learning techniques. Topic modeling is performed using Latent Dirichlet Allocation (LDA) or Non-Negative Matrix Factorization (NMF) to identify thematic patterns within lyrical content. Lyric generation utilizes recurrent neural networks (RNNs) or transformer architectures to create contextually appropriate textual content.

Real-time feedback mechanisms are integrated throughout the songwriting tools to provide artists with immediate assessment of generated content quality and copyright compliance. The feedback system includes harmonic analysis modules that evaluate chord progressions for musical coherence and originality. Melodic analysis components assess generated melodies for singability, memorability, and distinctiveness from existing copyrighted works.

Platform 100 may include a copyright licensing chatbot 190 comprising an intelligent chatbot system configured to interact with potential licensees requesting intellectual property usage rights. The system operates as an agent or plugin to existing large language model platforms including ChatGPT, Bard, and other conversational AI systems. The bot questions users on usage attributes including commercial versus non-commercial models, timeframe requirements, and geographical scope including country, state, and city of intended usage.

The licensing bot system performs risk profile determination based on gathered information using machine learning algorithms trained on historical licensing data and infringement patterns. High-risk assessments are automatically escalated to third parties for human assessment and review. The system maintains integration with digital watermarking capabilities to ensure all licensed content receives appropriate tracking mechanisms for compliance monitoring.

A dynamic pricing and subscription platform is integrated within platform 100, including a dynamic pricing engine configured to adjust licensing costs based on market factors, demand patterns, and seasonality using advanced AI algorithms. Customer segmentation is performed based on music preferences, listening habits, demographic information, and usage history. The system generates personalized subscription plans and bundling options tailored to individual user requirements and preferences.

Revenue optimization is achieved through dynamic pricing strategies that consider real-time market conditions, competitor pricing, and demand elasticity. The pricing engine employs reinforcement learning techniques to continuously optimize pricing decisions based on conversion rates, customer lifetime value, and market penetration goals.

Platform 100 further includes a copyright crawler system configured to sample content streams from Internet sources to identify unlicensed or mis-licensed content. The system uses machine learning algorithms to detect digital watermarks from images and sounds across various online platforms and content distribution networks. Cross-referencing algorithms compare detected material with intellectual property licenses currently in force to identify potential violations.

Automated response actions are triggered when violations are detected, including generation of licensing proposals, cease and desist letters, or flagging for human legal intervention. The crawler system maintains real-time monitoring capabilities across multiple content platforms including streaming services, social media platforms, and file-sharing networks.

The system architecture supports six main functional areas: AI media origination identification, AI powered songwriting tools, model architecture iteration, system for developing songwriting suggestions, copyright licensing system, and system for generating personalized subscription plans. Each functional area operates as an integrated component within the overall platform while maintaining independent operational capabilities.

Model architecture iteration capabilities within platform 100 enable continuous improvement of AI generation quality through systematic evaluation and refinement of underlying machine learning models. The system employs A/B testing methodologies to compare performance of different model configurations and architectures. Performance metrics include generation quality scores, copyright compliance rates, user satisfaction ratings, and computational efficiency measurements.

The songwriting suggestions development system provides real-time creative assistance to artists and composers through integration with digital audio workstations and songwriting software. The system analyzes partial compositions and provides contextually appropriate suggestions for chord progressions, melodic developments, lyrical content, and structural arrangements. Machine learning models are trained on extensive databases of successful musical compositions across various genres and time periods.

In operation, platform 100 receives a request to transform predetermined music content 110 using generative artificial intelligence system 120, wherein the predetermined music content is protected by copyright and digitally controlled by cloud-based authorization server 160. The system receives user requests to create derivative works including prompts specifying user-specific themes for the derivative work creation process.

AI modeling system 180 models the owner of the copyright using trained AI models that predict owner approval likelihood based on historical licensing patterns, content characteristics, and licensing terms. The system approves the creation of derivative works in response to modeling predictions indicating probable owner approval. Upon approval, generative artificial intelligence system 120 creates the derivative work incorporating elements from the predetermined content according to the user-specified theme and creative parameters.

Digital watermarking system 170 marks completed derivative works with digital watermarks for tracking usage and compliance monitoring. The watermarking process ensures that all generated content maintains traceable connections to original source material and licensing agreements. The system maintains comprehensive logs of all derivative work creation activities, licensing decisions, and usage tracking information.

Platform 100 provides a comprehensive solution to the technical challenges of AI-generated music creation while maintaining compliance with copyright law and intellectual property rights. The integrated approach combines advanced AI generation capabilities with robust copyright management, licensing automation, and usage tracking to create a complete ecosystem for legal AI music generation and distribution.

Advantageously, the platform 100 addresses the growing concern in the music industry regarding the use of copyrighted material by AI engines to create derivative works. This concern is not just theoretical but has real-world implications. For instance, consider a scenario where an AI engine uses a copyrighted melody from a popular song to create a new piece of music.

Without proper management and control, this could lead to copyright infringement, resulting in legal disputes and potential financial losses for the original copyright holder. The platform ensures that the use of copyrighted material is properly managed. This is achieved through a series of checks and balances. For example, when a user submits a request to create a derivative work, the platform first verifies the copyright status of the original content. If the content is copyrighted, the platform then checks whether the user has the necessary permissions to use the content. This could involve checking a database of licensing agreements or contacting the copyright holder directly. The rights of the copyright holders are respected in this process. This is not just a matter of legal compliance, but also of ethical business practices. By ensuring that copyright holders are properly compensated for the use of their work, the platform promotes a fair and sustainable music industry.

The platform 100 uses a cloud-based authorization server 160 to digitally control the copyrighted predetermined music content 110. This server acts as a gatekeeper, controlling access to the copyrighted content. For example, if a user tries to access the content without the necessary permissions, the server can deny the request. The server can also track the use of the content, providing valuable data on how, when, and by whom the content is being used. This digital control is particularly important in the context of the ongoing legal battles between record labels and AI engines over the unauthorized use of copyrighted material. For instance, in a recent case, a record label sued an AI engine for using a copyrighted melody without permission.

The AI engine argued that it had created a new, original work, but the court ruled in favor of the record label. With the platform, such disputes could be avoided, as the use of copyrighted material is controlled and tracked from the outset. The platform also provides a platform for the proper management of IP rights. This includes not only copyright, but also related rights such as performance rights and mechanical rights. The platform allows for the registration, administration, and enforcement of these rights, providing a one-stop solution for IP management in the music industry.

The payment of royalties to artists, music labels, and distribution partners is also facilitated by the platform. For example, when a derivative work is created and sold, the platform can automatically calculate and distribute the appropriate royalties. This ensures that all parties involved in the creation and distribution of the music are fairly compensated. Additionally, the platform receives a user request 130 to create a derivative work using the generative artificial intelligence system 120. The user request 130 can include a prompt from the user to cause the generative artificial intelligence to create the derivative work as a function of the predetermined content and one or more user specific themes for the derivative work. Advantageously, the platform 100 can allow for the creation of derivative works using generative artificial intelligence systems 120, which is a type of AI that can focus on creating new content in contrast to more traditional AI components that can solve specific tasks with predefined rules.

The user request 130 includes a prompt that triggers the generative AI systems 120 to create the derivative work based on the predetermined content and the one or more user-specific themes. This allows for the creation of unique and personalized derivative works, while ensuring that the use of the copyrighted material is properly managed and controlled.

The platform 100 also provides a basis for the negotiation and execution of licensing agreements, ensuring that the rights of the copyright holders are respected and that they are compensated for the use of their work. The platform then determines if the derivative work is approved for creation using AI modeling of the content owners. In response to determining that the derivative work is approved, it creates the generative artificial intelligence derivative work and marks it with a digital watermark for tracking use of the generative artificial intelligence derivative work.

In this example, the content is music. Advantageously, the platform 100 can use AI modeling to determine if the derivative work is approved for creation. This can ensure that the derivative work is created in a manner that respects the rights of the content owner. Once the derivative work is approved, the platform 100 can create the derivative work using the generative AI system 120 and can mark the derivative work with a digital watermark. This allows for the tracking of the use of the derivative work, ensuring that the rights of the copyright holders are respected and that they are compensated for the use of their work.

The platform 100 also provides a platform for the reporting and payment of royalties, ensuring that the artists, music labels, and distribution partners are compensated for the use of their work. This is particularly important in the context of the music industry, where the unauthorized use of copyrighted material is a major concern. It will be understood that the term generative artificial intelligence as used herein may refer to a type of AI technology that can autonomously generate new content, such as music or other forms of media, based on learned patterns and inputs from existing copyrighted content. It will be understood that the term generative artificial intelligence derivative work as used herein may refer to a new piece of content, such as a song or artwork, which is created by an AI system using inspiration or elements from existing copyrighted material and is marked with a digital watermark for tracking its use.

It will be understood that the term digital watermark as used herein may refer to an embedded and often imperceptible marker or identifier in a digital asset, such as audio, video, or image data, which can be used for copyright protection, content tracking, and verification of the authenticity or ownership of the derivative work. It will be understood that the term cloud-based authorization server as used herein may refer to a remote server hosted on the internet that manages and verifies user permissions for accessing and manipulating copyrighted content, such as music, in the creation of derivative works. It will be understood that the term AI modeling as used herein may refer to the process or method employed by the generative artificial intelligence system to create derivative works, such as music, based on user prompts and themes from copyrighted content. It will be appreciated by the person of skill in the art that various modifications may be made to the above-described examples without departing from the scope of the embodiments disclosed herein as defined by the appended claims.

In embodiments, the platform can protect copyrights and derivatives in a world of Artificial Intelligence.

The rights owner platform includes creative content such as interviews, approved and licensed derivative works, tracks fees and royalties, received payments, derivative rights held by rightful owners, revenue share management, and the like. The rights owner platform provides control over new business models and the ability to solve problems.

In embodiments, the platform 100 can provide ownership and licensing of existing assets, control of your assets and when you get paid for them, revenue sharing controls, new revenue generation from derivative works, and the ability to publish rights into the tool.

In embodiments, the platform 100 provides mechanisms to monitor copyright infringement and fair use, to enhance the quality of the AI-generated music, and to increase the transparency and interpretability of the AI algorithms. In these examples, AI can be used in music creation, while ensuring respect for the rights of artists and copyright holders and maintaining the artistic integrity of music by allowing owners the ability to control assets and derivative works.

In embodiments, the platform 100 can provide for the creation of AI-generated music, derivative works and how artists and music labels receive requests and provide approvals to users of large language model (LLM) artificial intelligent engines that want to use one or more the artists' voices, existing music, derivative works, images and likeness among other attributes.

In embodiments, the platform 100 can include collecting and preprocessing data, which can include gathering raw data from various sources, such as databases, web sources, hidden information, user interactions, sensors, etc. The data is then cleaned, transformed, and organized into a structured format suitable for analysis and modeling. In these examples, the platform 100 can include feature engineering to select and transform relevant data attributes (features) that will be used as input for AI algorithms. Data analytics techniques can be employed to identify significant features, remove irrelevant ones, and create new ones that might enhance the model's performance, which can be shown to positively impact the AI system's accuracy and efficiency.

In embodiments, the platform 100 can include exploratory data analysis to understand the data's characteristics, uncover patterns, and identify potential issues. By visualizing and analyzing data through EDA techniques, the platform can gain insights into relationships between variables, detect outliers, and determine the appropriate data pre-processing steps.

In embodiments, the platform 100 can include data analytics for model selection and evaluation of the right AI model for a given task such as cross-validation, performance metrics, and hypothesis testing, The platform 100 can compare and evaluate different models to identify the most suitable one for the problem at hand.

In embodiments, the platform 100 can include training and optimization. By way of these examples, AI systems, during the training phases, can use data analytics to adjust model parameters and optimize the model's performance using techniques like gradient descent, optimization algorithms, and hyperparameter tuning to fine-tune the model based on the data.

In embodiments, the platform 100 can include real-time data analytics for AI systems operating in real-time or streaming environments. The embedded data analytics processes can be employed to continuously monitor and analyze incoming data. This can enable the AI system to adapt and make predictions or decisions in real-time, which is crucial for all types of AI applications like recommendation systems, new software applications, fraud detections, and more.

In embodiments, the platform 100 can include anomaly detection and error handling with data analytics techniques that can be employed to identify anomalies or errors in the AI system's performance. For instance, anomaly detection algorithms can help identify unusual patterns in data or detect when the AI model is making unexpected predictions. This feedback loop allows AI developers to improve the model and its performance over time.

In embodiments, the platform 100 can include explainability and interpretability mechanisms to understand how AI systems arrive at their decisions. By way of these examples, data analytics can be used to interpret the AI model's behavior, identify important features contributing to the output, and ensure that the platform is making decisions based on transparent and explainable factors.

In embodiments, the platform 100 can include data analytics for artificial intelligence using continuous improvement. By way of these examples, embedded data analytics processes can enable AI platforms to continuously learn and improve over time. By monitoring the performance of the AI system, collecting feedback data, and analyzing user interactions, AI developers can iteratively update the model to enhance its accuracy and adapt to changing data patterns.

It will be appreciated in light of the disclosure that data analytics processes can be deeply intertwined with the functioning and success of artificial intelligence platforms in collecting, preprocessing, and analyzing data, selecting appropriate models, optimizing performance, enabling continuous improvement and adaptation, and the like.

It will be appreciated in light of the disclosure that advanced and intelligent systems can continue to solve complex problems across various domains with the integration of data analytics and artificial intelligence including data scoring, real-time aggregation of multiple data streams, automated data modeling, data predictions, model test, validation and revalidation, and the like.

### AI Media LLM Origination Identification Method and System

Before the advent of Generative AI music creation (GAI-MC) software companies, content creators/artists would contract with a record label company to manage their intellectual property rights and to license the use of their media/content. Labels would leverage its network of distribution channels, including streaming platforms, digital music stores and physical retailers to sell the music. Record labels would collect revenues and distribute the agreed upon portion of the revenue to their contracted artists in the form of royalties.

Today, GAI-MC have leveraged machine learning (ML) with AI LLM's (Large Language Models) to take the media created by the artists and combine that work product with other content creators' work products and some media of their own to produce music products (Derivatives) that compete with and ultimately redirect revenue from the record labels and the creative artists to which record labels are contractually obligated to protect.

The GAI-MC/LLM companies train their generative AI models on existing music and art. GAI-MC does not share the revenues with the original artists nor with their record label companies when training on the copyrights (songs, films, art). GAI-MC use popular lyrics, voices and images and essentially remove attribution to the original artists. Without the artists' recognizable content, the AI-generated content would not be viable.

In embodiments, the platform 100 can bridge the gap between GAI-MC business practices and protecting the artists' intellectual property rights by identifying which LLM supported GAI-MC produced any given piece of media (audio, visual, etc.). In embodiments, a media file source identification process includes: Collection of media produced by original artists; Collection of media produced by GAI-MC (AI-LLM); Scanning bytes of media file under test for GAI-MC identification strings; identifying known GAI-MC signatures; media/audio/video/image forensics; (NIL) music, video, art, name image likeness; identify and catalog all original, digital source media patterns; identify catalog all GAI-MC digital source patterns; pattern matching to identify GAI-MC fingerprints; generate intellectual property rights violations report; send the report to appropriate administrative/management team(s); and master derivatives, master/derivative re-records; and reconnaissance.

In addition to collecting data from the original artists and GAI-MC LLM companies, the platform can employ BOTs to obtain media files from digital media vendors and sources across the entertainment industry (Music, Film, TV, Other). Similar to before, when collected media files directly from GAI-MC LLM companies, BOTs can be employed to collect media files that could have been derived from GAI-MC (LLM) tools a/k/a “derivatives” from digital media vendors and other sources. In embodiments, an AI media derivatives reconnaissance process can include registering accounts with digital media vendors/sources; life cycle management of the accounts; configuring and crafting integration AIs; identification of new media to collect/analyze; where necessary, payment for the media, metered collection of the media; media file source identification and summary.

GAI-MC (AI LLM's) training on creations by artists vacuums up previous works, subtly altering digital media and in some situations, to mask theft. As the GAI-MC profits from the modified works, the original creators, in some instances, remain without credit or compensation for their intellectual property.

In embodiments, the systems and methods provide identifying which LLM and music aligned software created the copyright derivatives in order to identify how many derivatives were created, how much money is owed, how much value was used to train the LLMs in order to create the derivatives.

AI-Powered Songwriting Tools Allowing Musical Artists to Benefit from Advanced Analysis, Emotional Context Recognition, Customizable Templates, and Other Collaborative AI Features Enhancing the Creative Process and Enabling the Generation of Original Compositions that Resonate with Listeners AI-Powered Songwriting Tools for Analyzing Patterns

The system utilizes Artificial Intelligence with natural language processing (NLP) to analyze vast databases of lyrics and music compositions. The system creates an “AI Platform-as-a-Service” (AI-PaaS) and application that allows the use of Enterprise Networks, Intranets, Internet, downloadable software, API's among other.

The detailed evaluation methods and metrics allow researchers and practitioners an effective assessment of the performance of NLP models and techniques on tasks such as lyric generation, sentiment analysis, and thematic classification, leading to the development of more accurate and reliable AI-powered systems for music analysis and songwriting.

This platform can be subscription based, provided as a free service, or licensed out to partners and musicians around the world. Additionally, a percentage of music royalties could be paid out to the platform owner for the development of successful songs.

The platform could also be utilized in conjunction with Generative AI platforms as a bolt-on application and allowing novices to create AI based music that can be then licensed as a derivative song.

A method, a process, and steps to develop the system are outlined below.

In embodiments, AI-powered songwriting tools for analyzing patterns include data collection and preprocessing, word embeddings and feature extraction, topic modeling and clustering, sentiment analysis, lyric generation and completion, lyrical analysis and annotation, and evaluation and validation.

Data collection and preprocessing may include gathering a large dataset of lyrics and music compositions from various sources such as music databases, streaming platforms, lyric websites, and digital libraries. The system may preprocess the data to clean and standardize it, including removing special characters, punctuation, and irrelevant metadata. The system may tokenize the text data into individual words or phrases to facilitate further analysis.

Word embeddings and feature extraction may include utilizing word embedding techniques such as Word2Vec, GloVe, or FastText to convert words into dense vector representations. The system may train word embeddings on the dataset of lyrics and music compositions to capture semantic relationships between words and phrases. The system may extract additional features from the text data, such as word frequencies, n-grams, and syntactic patterns, to capture more detailed linguistic information.

Topic modeling and clustering may include applying topic modeling techniques such as Latent Dirichlet Allocation (LDA) or Non-Negative Matrix Factorization (NMF) to identify latent topics or themes present in the lyrics and music compositions. The system may cluster similar lyrics and compositions based on their thematic content using clustering algorithms like K-means or hierarchical clustering. The system may visualize the clusters and topics using dimensionality reduction techniques such as t-SNE or PCA to gain insights into the underlying structure of the data.

Sentiment analysis may include performing sentiment analysis on the lyrics to determine the emotional tone and sentiment expressed in the text. The system may utilize pre-trained sentiment analysis models or train custom models on annotated datasets to classify lyrics into categories such as positive, negative, or neutral. The system may extract sentiment-related features such as sentiment polarity scores or emotion labels to quantify the emotional content of the lyrics.

Lyric generation and completion may include training language models such as recurrent neural networks (RNNs) or transformer architectures on the dataset of lyrics to generate new lyrics or complete existing ones. The system may use techniques like sequence-to-sequence learning or masked language modeling to generate coherent and contextually relevant lyrics. The system may fine-tune the language models on specific genres or artists' styles to capture domain-specific linguistic patterns and nuances.

Lyrical analysis and annotation may include analyzing lyrical attributes such as rhyme schemes, poetic devices, and lyrical themes using rule-based or machine learning-based approaches. The system may develop annotation tools to annotate lyrics with metadata such as genre, mood, tempo, and lyrical themes for downstream analysis and classification tasks. The system may create labeled datasets for supervised learning tasks such as genre classification, mood detection, or thematic analysis of lyrics.

Evaluation and validation may include evaluating the performance of NLP models and techniques on tasks such as lyric generation, sentiment analysis, and thematic classification using appropriate evaluation metrics. The system utilizes Artificial Intelligence with natural language processing (NLP) to analyze vast databases of lyrics and music compositions, creating an “AI Platform-as-a-Service” (AI-PaaS) and application that allows the use of Enterprise Networks, Intranets, Internet, downloadable software, and APIs.

### Evaluation Metrics for Lyric Generation

In embodiments, the system may compute perplexity to measure how well the language model predicts the next word in a sequence of lyrics. In embodiments, lower perplexity indicates better predictive performance of the model.

In embodiments, the system may calculate the BLEU (Bilingual Evaluation Understudy) score to evaluate the quality of generated lyrics compared to reference lyrics. BLEU measures the overlap between generated and reference lyrics based on n-gram precision.

In embodiments, the system may use the ROUGE (Recall-Oriented Understudy for Gisting Evaluation) score to assess the quality of generated lyrics by comparing them with reference lyrics. ROUGE evaluates the similarity of n-grams and word sequences between generated and reference lyrics.

In embodiments, the system may compute diversity metrics such as diversity ratio or unique n-gram count to measure the diversity of generated lyrics. Higher diversity indicates a wider range of vocabulary and lyrical variations in the generated lyrics.

In embodiments, the system may conduct human evaluation studies where human judges assess the quality, coherence, and creativity of generated lyrics. In embodiments, the system may use rating scales or qualitative feedback to gather subjective assessments of the generated lyrics.

In embodiments, the system may evaluate the accuracy of rhyme schemes and metrical patterns in the generated lyrics compared to human-written lyrics. Measure metrics may include, for example, rhyme density, rhyme scheme consistency, and metrical regularity.

In embodiments, the system may assess the semantic coherence of generated lyrics by computing semantic similarity scores between consecutive lines or verses. In embodiments, the system may use pre-trained word embeddings or semantic similarity measures to quantify semantic coherence.

In embodiments, the system may analyze the thematic consistency of generated lyrics by comparing them with a predefined set of thematic categories or topics. In embodiment, the system may compute topic coherence metrics or thematic similarity scores to assess how well the generated lyrics align with specific themes.

In embodiments, the system may conduct user preference studies where listeners rate and compare the generated lyrics with human-written lyrics. In embodiments, the system may use Likert scales or preference rankings to gather user feedback on the appeal and relevance of the generated lyrics.

In embodiments, the system may evaluate the performance of lyric generation models in real-world scenarios, such as songwriting collaborations or music production projects. In embodiments, the system may monitor user engagement, satisfaction, and adoption rates to assess the practical utility of the generated lyrics.

### Evaluation Metrics for Sentiment Analysis

In embodiments, the system may calculate the accuracy of sentiment classification models by comparing predicted sentiment labels with ground truth labels. In embodiments, accuracy measures the proportion of correctly classified instances across all samples.

In embodiments, the system may compute precision, recall, and F1 score to evaluate the performance of sentiment classifiers, especially in imbalanced datasets. In embodiments, precision measures the proportion of correctly predicted positive instances among all predicted positive instances, while recall measures the proportion of correctly predicted positive instances among all actual positive instances.

In embodiments, the system may generate a confusion matrix to visualize the performance of sentiment classifiers across different sentiment categories. In embodiments, the system may analyze true positives, false positives, true negatives, and false negatives to understand model errors and biases.

In embodiments, the system may plot the Receiver Operating Characteristic (ROC) curve and calculate the Area Under the Curve (AUC-ROC) to assess the performance of sentiment classifiers across different thresholds. In embodiments, AUC-ROC measures the model's ability to distinguish between positive and negative instances.

In embodiments, the system may perform k-fold cross-validation to evaluate the generalization performance of sentiment classifiers on unseen data. In embodiments, the system may split the dataset into k subsets, train the model on k−1 subsets, and evaluate on the remaining subset, repeating the process k times.

In embodiments, the system may use focal loss, a modified loss function designed to address class imbalance, to train sentiment classifiers more effectively. In embodiments, focal loss down-weights well-classified samples and focuses on hard-to-classify samples, improving model performance on minority classes.

In embodiments, the system may extend evaluation metrics such as accuracy, precision, recall, and F1 score to multi-class sentiment analysis tasks with more than two sentiment categories. In embodiments, the system may calculate macro-averaged and micro-averaged metrics to account for class imbalances.

In embodiments, the system may evaluate the transferability and robustness of sentiment classifiers across different domains or datasets. In embodiments, the system may train sentiment classifiers on one dataset/domain and evaluate their performance on a different dataset/domain to assess generalization ability.

In embodiments, the system may analyze the temporal dynamics of sentiment in music lyrics over time, using time-series analysis techniques to identify trends, patterns, and fluctuations in sentiment expression.

In embodiments, the system may incorporate user feedback mechanisms into sentiment analysis models to adapt and improve sentiment predictions based on real-time user interactions and preferences.

### Evaluation Metrics for Thematic Classification

In embodiments, the system may calculate the accuracy of thematic classification models by comparing predicted thematic labels with ground truth labels. In embodiments, accuracy measures the proportion of correctly classified instances across all samples.

In embodiments, the system may compute precision, recall, and F1 score to evaluate the performance of thematic classifiers, especially in imbalanced datasets. In embodiments, precision measures the proportion of correctly predicted instances among all predicted instances for a particular theme, while recall measures the proportion of correctly predicted instances among all actual instances of that theme.

In embodiments, the system may generate a confusion matrix to visualize the performance of thematic classifiers across different thematic categories. In embodiments, the system may analyze true positives, false positives, true negatives, and false negatives to understand model errors and biases.

In embodiments, the system may plot the Receiver Operating Characteristic (ROC) curve and calculate the Area Under the Curve (AUC-ROC) to assess the performance of thematic classifiers across different thresholds. In embodiments, AUC-ROC measures the model's ability to distinguish between different thematic categories.

In embodiments, the system may perform k-fold cross-validation to evaluate the generalization performance of thematic classifiers on unseen data. In embodiments, the system may sit the dataset into k subsets, train the model on k−1 subsets, and evaluate on the remaining subset, repeating the process k times.

In embodiments, the system may use focal loss, a modified loss function designed to address class imbalance, to train thematic classifiers more effectively. In embodiments, focal loss down-weights well-classified samples and focuses on hard-to-classify samples, improving model performance on minority thematic categories.

In embodiments, the system may extend evaluation metrics such as accuracy, precision, recall, and F1 score to multi-label thematic classification tasks where instances can belong to multiple thematic categories simultaneously. In embodiments, the system may calculate metrics such as Hamming loss, subset accuracy, and micro/macro-averaged F1 score to assess model performance in multi-label scenarios.

In embodiments, the system may evaluate the transferability and robustness of thematic classifiers across different domains or datasets. In embodiments, the system may train thematic classifiers on one dataset/domain and evaluate their performance on a different dataset/domain to assess generalization ability.

In embodiments, the system may incorporate user feedback mechanisms into thematic classification models to adapt and improve thematic predictions based on real-time user interactions and preferences.

In embodiments, the system may evaluate the interpretability of thematic classification models by analyzing feature importance, decision boundaries, and model explanations to understand how the models make predictions and identify influential features/themes. In embodiments, the system may validate the accuracy and robustness of the models through cross-validation, held-out testing, or comparison with human annotations.

### Cross-Validation

In embodiments, cross-validation includes data preparation, validation, and aggregation. For example, data preparation may include splitting the dataset into k-folds, typically between 5 to 10 folds, ensuring that each fold contains a balanced representation of samples across classes and variations in data distribution. The system may randomize the order of samples to minimize bias and ensure that each fold is representative of the entire dataset.

Model training may include training the NLP model on k−1 folds of the dataset, using various algorithms and hyperparameters to explore different configurations and architectures. The system may use techniques such as grid search or randomized search to tune model parameters and optimize performance.

Validation may include evaluating the trained model on the held-out fold (the k-th fold) to obtain performance metrics such as accuracy, precision, recall, F1-score, and/or mean squared error, depending on the task.

The system may repeat steps 2 and 3 for each fold, ensuring that each fold serves as both a training set and a validation set exactly once.

In embodiments, aggregation may include computing the average performance metrics across all folds to obtain an overall estimate of the model's accuracy and generalization ability. The system may analyze variance between fold performances to assess model stability and robustness across different data splits.

### Held-Out Testing

In embodiments, held-out testing may include data splitting, model training and validation, evaluation, and analysis. For example, data splitting may include dividing the dataset into training, validation, and held-out testing sets, typically using an 80-10-10 split ratio or similar proportions. The system may ensure that the held-out testing set is representative of the overall dataset and includes a diverse range of samples across different classes and variations.

Model training and validation may include training the NLP model on the training set and fine-tune hyperparameters using the validation set to optimize performance. The system may monitor model performance on the validation set during training to prevent overfitting and guide early stopping decisions.

Evaluation may include evaluating the final trained model on the held-out testing set to obtain unbiased estimates of its performance on unseen data. The system may compute evaluation metrics such as accuracy, precision, recall, F1-score, and/or mean squared error to assess model effectiveness across different evaluation criteria.

Analysis may include analyzing the model's performance on the held-out testing set and comparing it with results from cross-validation to validate consistency and reliability. The system may identify potential shortcomings or areas for improvement based on performance metrics and qualitative analysis of model predictions.

Comparison with Human Annotations

In embodiments, comparison with human annotations includes annotation preparation, evaluation using metrics, consistency in annotation, model comparison, and qualitative analysis. For example, annotation preparation may include collecting human annotations or ground truth labels for a subset of the dataset, either through manual annotation by domain experts or crowdsourcing platforms. The system may ensure that the annotations cover diverse aspects of the task, such as sentiment polarity, thematic classification, or lyric quality, depending on the evaluation objectives.

Evaluation metrics may include defining evaluation metrics that quantify agreement between model predictions and human annotations, such as Cohen's kappa coefficient, Fleiss' kappa, or Pearson correlation coefficient. The system may choose appropriate metrics based on the nature of the task and the characteristics of the dataset.

Annotation consistency may include assessing inter-annotator agreement among human annotators to ensure consistency and reliability of the ground truth labels. The system may compute agreement statistics such as Fleiss' kappa or intraclass correlation coefficient (ICC) to quantify the level of agreement between annotators.

Model comparison may include evaluating the NLP model's performance against human annotations using the defined evaluation metrics to measure alignment with human judgments. The system may compare model predictions with human annotations across different subsets of the dataset to identify strengths, weaknesses, and areas for improvement.

Qualitative analysis may include conducting qualitative analysis of model predictions and human annotations to understand discrepancies, errors, and patterns of agreement or disagreement. The system may use human feedback and domain expertise to interpret results and provide insights into the model's behavior and decision-making process.

Iterate on the model architecture, hyperparameters, and training procedures based on evaluation results and feedback from domain experts.

### Model Architecture Iteration

In embodiments, model architecture iteration may include reviewing evaluation results, gathering feedback from domain experts, identifying model limitations, exploring architectural modifications, implementing prototype models, evaluating prototype models, analyzing results and gathering feedback, and iterating based on feedback. For example, reviewing evaluation results may include analyzing performance metrics obtained from cross-validation, held-out testing, and comparison with human annotations to identify areas of improvement and potential shortcomings in the current model architecture.

Gathering feedback from domain experts may include soliciting feedback from domain experts, including music industry professionals, linguists, and NLP researchers, to gain insights into the specific requirements and challenges of music analysis tasks.

Identifying model limitations may include identifying limitations or deficiencies in the current model architecture, such as inadequate representation of musical semantics, lack of context awareness, or difficulty in capturing subtle nuances of lyrical content.

Exploring architectural modifications may include experimenting with architectural modifications to address identified limitations, such as adding additional layers, incorporating attention mechanisms, or integrating domain-specific knowledge into the model.

Implementing prototype models may include developing prototype models with alternative architectures or architectural components to test their effectiveness in improving model performance and addressing specific challenges identified in the evaluation process.

Evaluating prototype models may include training and evaluating prototype models using the same evaluation procedures as before, including cross-validation, held-out testing, and comparison with human annotations. The system may compare performance metrics of prototype models with those of the baseline model to assess improvements or regressions in model accuracy and robustness.

Analyzing results and gathering feedback may include analyzing evaluation results of prototype models and gathering feedback from domain experts to assess the impact of architectural modifications on model performance and suitability for music analysis tasks.

Iterating based on feedback may include incorporating feedback from domain experts and evaluation results into further iterations of the model architecture, refining architectural modifications, removing ineffective components, and introducing new features as needed.

### Hyperparameter Tuning Iteration

Hyperparameter tuning iteration may include defining hyperparameter space, grid search or random search, train and validate models, evaluate performance, analyze hyperparameter influence, and iterate based on results. For example, defining the hyperparameter space may include defining the hyperparameter space to explore, including parameters such as learning rate, batch size, dropout rate, layer sizes, activation functions, optimizer settings, and regularization techniques.

Grid search or random search may include performing grid search or random search over the defined hyperparameter space to systematically explore different combinations of hyperparameters and their impact on model performance.

Training and validating models may include training and validating models using the selected hyperparameter configurations on the training and validation sets, respectively, using the same evaluation procedures as before.

Evaluating performance may include evaluating model performance for each hyperparameter configuration based on performance metrics obtained from cross-validation, held-out testing, and comparison with human annotations.

Analyzing hyperparameter influence may include analyzing the influence of individual hyperparameters on model performance and identifying optimal settings that lead to improved accuracy, convergence speed, and generalization ability.

Iterating based on results may include iterating on the hyperparameter tuning process based on evaluation results, adjusting the hyperparameter space, search strategy, or evaluation criteria as needed to further optimize model performance.

### Training Procedure Iteration

Training procedure iteration may include data augmentation and regularization, learning rate scheduling, batch size and optimization algorithm use, model ensemble and transfer learning, iterative training and fine tuning, monitoring convergence and early stopping, and iterating based on performance. For example, data augmentation and regularization may include exploring techniques for data augmentation and regularization to enhance model robustness and reduce overfitting, such as dropout, batch normalization, data augmentation, and early stopping.

Learning rate scheduling may include experimenting with learning rate scheduling strategies, such as cosine annealing, exponential decay, or warmup schedules, to improve model convergence and stability during training.

Batch size and optimization algorithms may include investigating the impact of batch size and optimization algorithms on model performance, considering options such as stochastic gradient descent (SGD), Adam, RMSprop, and their variants.

Model ensemble and transfer learning may include exploring techniques such as model ensemble and transfer learning to leverage pre-trained models or ensemble multiple models to improve model generalization and robustness.

Iterative training and fine-tuning may include conducting iterative training and fine-tuning of the model on the training data, monitoring performance on the validation set and adjusting training procedures based on observed trends and patterns.

Monitoring convergence and early stopping may include monitoring model convergence during training and implementing early stopping mechanisms to prevent overfitting and avoid wasting computational resources on training epochs with diminishing returns.

Iterating based on performance may include continuously iterating on the training procedure based on evaluation results, feedback from domain experts, and observed behavior of the model during training and validation. The system may employ machine learning algorithms to identify patterns in lyrical themes, rhyme schemes, chord progressions, and melodic structures.

### Data Preprocessing

Data preprocessing may include data collection, text cleaning, tokenization, and feature extraction. For example, data collection may include gathering a diverse dataset of song lyrics, chord progressions, and melodic structures from various sources such as online music databases, lyric websites, and MIDI repositories.

Text cleaning may include removing non-essential characters, punctuation, and special symbols from the lyrics to standardize the text format and improve processing efficiency. The system may normalize the text by converting it to lowercase and removing stopwords and common words that carry little semantic meaning.

Tokenization may include tokenizing the lyrics into individual words or n-grams to represent each lyric line as a sequence of tokens for further analysis.

Feature extraction may include extracting linguistic features such as word frequency, vocabulary richness, sentiment scores, and thematic keywords to capture semantic information from the lyrics.

In embodiments, feature extraction may relate to bag-of-words representation, word embeddings, and sequence models.

Bag-of-words representation may include representing each song lyric as a bag-of-words or bag-of-n-grams vector, where each dimension corresponds to the frequency or presence of a specific word or phrase in the lyrics.

The system may use techniques such as TF-IDF (Tenn Frequency-Inverse Document Frequency) to weigh the importance of each word based on its frequency across lyrics.

Word embeddings may include generating word embeddings using pre-trained word embedding models such as Word2Vec, GloVe, or FastText to capture semantic relationships between words in the lyrics. The system may represent lyrics as dense vectors in a continuous vector space, enabling the model to learn contextual similarities and associations between words.

Sequence modeling may include encoding sequential patterns in the lyrics using recurrent neural networks (RNNs), long short-term memory (LSTM) networks, or transformer architectures such as BERT or GPT to capture dependencies between words and phrases. The system may model temporal dynamics and hierarchical structures in the lyrics to capture long-range dependencies and semantic coherence.

### Algorithm Selection

In embodiments, algorithm selection includes topic modeling, sentiment analysis, rhyme scheme detection, chord progression analysis, and melodic pattern recognition.

Topic modeling may include employing algorithms such as Latent Dirichlet Allocation (LDA) or Non-Negative Matrix Factorization (NMF) to identify latent themes and topics in the lyrics by clustering words that co-occur frequently across different songs. The system may analyze topic distributions and interpret topic clusters to identify recurring lyrical themes and motifs.

Sentiment analysis may include applying sentiment analysis algorithms such as VADER (Valence Aware Dictionary and sEntiment Reasoner) or deep learning-based classifiers to identify sentiment polarity (positive, negative, neutral) and emotional tone in the lyrics. The system may extract sentiment scores and emotional attributes to quantify the emotional content of songs and detect shifts in mood or tone.

Rhyme scheme detection may include developing algorithms to detect rhyme schemes in the lyrics by analyzing patterns of rhyme and repetition in the end words of each line. The system may use sequence alignment algorithms such as dynamic programming or edit distance to identify rhyming patterns and measure rhyme similarity between lyric lines.

Chord progression analysis may include employing chord recognition algorithms such as chroma-based methods or deep learning models trained on music audio signals to extract chord sequences from audio recordings or MIDI files. The system may analyze chord progressions using music theory principles and statistical methods to identify common chord sequences, harmonic patterns, and tonal relationships.

Melodic pattern recognition may include developing algorithms to analyze melodic structures in MIDI files or audio recordings using signal processing techniques such as pitch detection, onset detection, and feature extraction. The system may apply pattern recognition algorithms such as hidden Markov models (HMMs), recurrent neural networks (RNNs), or sequence-to-sequence models to identify recurring melodic motifs and melodic contours.

### Algorithm Selection and Why

In embodiments, algorithm selection includes rationale for specific algorithmic approaches including LDA (Latent Dirichlet Allocation), BERT (Bidirectional Encoder Representations from Transformers), CRF (Conditional Random Fields), deep learning models, and graph-based algorithms.

LDA (Latent Dirichlet Allocation) may be suitable for identifying latent topics and themes in song lyrics by modeling the underlying topic distributions. The system may utilize LDA to provide interpretable results that facilitate thematic classification and analysis.

BERT (Bidirectional Encoder Representations from Transformers) may be effective for capturing contextual semantic relationships between words and phrases in the lyrics. The system may leverage pre-trained language representations to capture nuanced meanings and associations.

CRF (Conditional Random Fields) may be well-suited for sequence labeling tasks such as named entity recognition (NER) or part-of-speech tagging in lyric analysis. The system may utilize CRF to model dependencies between adjacent tokens and incorporate contextual information into the prediction process.

Deep learning models including RNNs, LSTMs, and Transformers may be ideal for modeling sequential patterns and long-range dependencies in song lyrics. The system may utilize these models to capture complex structures and temporal dynamics in the data, enabling the detection of subtle lyrical patterns and motifs.

Graph-based algorithms may be effective for analyzing structural relationships and dependencies between words, phrases, and themes in the lyrics. The system may enable the representation of lyrical content as a graph and the application of graph-based algorithms for pattern recognition and clustering.

The system may develop algorithms that generate songwriting suggestions based on analyzed patterns, providing artists with creative inspiration through the implementation of these selected algorithmic approaches.

### Steps to Develop Songwriting Suggestions Algorithm

In embodiments, developing songwriting suggestions algorithms includes data collection and preprocessing, pattern extraction, feature representation, recommendation generation, personalization and customization, evaluation and validation, and iterative improvement.

Data collection and preprocessing may include gathering a diverse dataset of song lyrics, chord progressions, and melodic structures, and preprocessing the data as outlined in previous steps.

Pattern extraction may include utilizing machine learning algorithms such as BERT or deep learning models to extract patterns in lyrical themes, rhyme schemes, chord progressions, and melodic structures from the preprocessed data. The system may apply techniques such as topic modeling, sentiment analysis, sequence labeling, and pattern recognition to identify meaningful patterns and motifs in the data.

Feature representation may include representing extracted patterns and features in a structured format suitable for recommendation generation, such as embedding vectors, graph representations, or sequence encodings.

Recommendation generation may include employing recommendation algorithms such as collaborative filtering, content-based filtering, or hybrid methods to generate songwriting suggestions based on the analyzed patterns. The system may leverage similarity metrics, clustering algorithms, or generative models to identify similar songs, lyrical themes, chord progressions, or melodic structures that may inspire artists.

Personalization and customization may include incorporating user preferences, artist characteristics, and contextual information into the recommendation process to personalize songwriting suggestions for individual artists. The system may allow artists to specify criteria such as genre, mood, tempo, or lyrical themes to tailor recommendations to their creative preferences.

### Selection of Machine Learning Algorithms

In embodiments, machine learning algorithm selection includes BERT (Bidirectional Encoder Representations from Transformers), deep learning models, graph-based algorithms, collaborative filtering and content-based filtering, and generative models.

BERT (Bidirectional Encoder Representations from Transformers) may be suitable for capturing contextual relationships between words and phrases in song lyrics, enabling the extraction of meaningful patterns and themes.

The system may use BERT for topic modeling, sentiment analysis, and semantic similarity calculation to inform recommendation generation.

Deep learning models (RNNs, LSTMs, Transformers) may be effective for modeling sequential patterns and dependencies in chord progressions and melodic structures, allowing for the extraction of recurring motifs and harmonic sequences. The system may generate songwriting suggestions by predicting the next chords or melodies based on learned patterns in the data.

Graph-based algorithms may be useful for representing relationships between songs, lyrics, and musical elements as a graph and applying graph-based recommendation techniques to identify similar songs or lyrical themes. The system may enable the exploration of structural similarities and connections between songs based on shared patterns and motifs.

Collaborative filtering and content-based filtering may include collaborative filtering algorithms that can recommend songs based on similarities between artists, genres, or song features, leveraging user interaction data to personalize suggestions. The system may use content-based filtering algorithms that can recommend songs based on textual analysis of lyrics, chord progressions, and melodic structures, focusing on the content similarity between songs.

Generative models may include generative models such as variational autoencoders (VAEs) or generative adversarial networks (GANs) that can generate novel chord progressions, melodies, or lyrical themes based on learned patterns in the data. The system may provide creative inspiration to artists by generating new songwriting ideas that incorporate observed patterns and motifs from existing songs. The system may implement data visualization tools to present insights and patterns in a user-friendly manner, aiding artists in understanding and utilizing the generated suggestions.

### Steps to Implement Data Visualization Tools

In embodiments, implementing data visualization tools includes data representation, feature selection, visualization design, tool development, dashboard creation, responsive design, and accessibility features.

Data representation may include representing analyzed patterns and insights from song lyrics, chord progressions, and melodic structures in a structured format suitable for visualization, such as feature vectors, graphs, or sequences.

Feature selection may include selecting key features and dimensions of the data to visualize, focusing on aspects that are relevant to songwriting suggestions and artist preferences, such as lyrical themes, chord progressions, sentiment, and genre.

Visualization design may include designing intuitive and user-friendly visualization interfaces that allow artists to explore and interact with the data effectively. The system may choose visualization techniques that convey insights clearly and facilitate understanding of patterns and relationships in the data.

Tool development may include developing data visualization tools using programming languages and libraries suited for interactive visualization, such as JavaScript (D3.js, Plotly.js), Python (Matplotlib, Seaborn), or R (ggplot2). The system may implement features such as interactive sliders, dropdown menus, and hover-over tooltips to enable user-driven exploration of the data.

Dashboard creation may include creating interactive dashboards that integrate multiple visualizations and allow artists to view different aspects of the data simultaneously. The system may organize visualizations into logical sections and provide navigation controls to facilitate seamless exploration of songwriting suggestions and insights.

Responsive design may include ensuring that data visualization tools are responsive and compatible with various devices and screen sizes, including desktops, tablets, and smartphones. The system may optimize layouts and interaction patterns for different viewing contexts to provide a consistent and enjoyable user experience.

Accessibility features may include implementing accessibility features such as alternative text descriptions, keyboard navigation, and screen reader compatibility to ensure that the visualization tools are accessible to users with disabilities.

### Selection of Visualization Techniques

In embodiments, selection of visualization techniques includes word clouds, bar charts and histograms, network graphs, heatmaps, timeline charts, interactive plots, and embedding visualizations.

Word clouds may include visualizing word frequencies and thematic keywords extracted from song lyrics using word clouds, with word size indicating frequency or importance. The system may provide artists with insights into dominant lyrical themes and recurring motifs in the analyzed songs.

Bar charts and histograms may include using bar charts and histograms to display distributions of sentiment scores, chord frequencies, or thematic categories in the data. The system may enable artists to compare the prevalence of different sentiments, chords, or themes across songs and genres.

Network graphs may include representing relationships between songs, artists, or lyrical themes as network graphs, with nodes representing entities and edges indicating connections. The system may allow artists to explore connections between songs based on shared patterns, collaborations, or thematic similarities.

Heatmaps may include visualizing pairwise similarities between songs or lyrical themes using heatmaps, with color intensity indicating similarity scores. The system may enable artists to identify clusters of similar songs or themes and explore relationships between them.

Timeline charts may include displaying temporal patterns and trends in song releases, genre popularity, or thematic evolution over time using timeline charts. The system may provide artists with insights into historical trends and changes in musical styles and themes.

Interactive plots may include implementing interactive scatter plots, line charts, or parallel coordinate plots that allow artists to explore correlations and relationships between multiple dimensions of the data. The system may enable brushing and linking interactions to highlight subsets of data and reveal patterns across different visualizations.

Embedding visualizations may include visualizing high-dimensional embeddings of songs, lyrics, or musical elements using techniques such as t-SNE (t-distributed stochastic neighbor embedding) or UMAP (Uniform Manifold Approximation and Projection). The system may enable artists to explore the spatial arrangement of songs in embedding space and identify clusters of similar songs or lyrical themes. The system may enable customization options for artists to specify preferences, such as genre, mood, or lyrical themes, to tailor the generated suggestions to their unique style.

### Customization Options Implementation

In embodiments, customization options implementation includes user interface elements, preference selection, filtering mechanisms, genre tagging and metadata, mood and emotion analysis, thematic keyword search, personalization profiles, and feedback mechanisms.

User interface elements may include interactive dropdown menus, sliders, or checkboxes in the visualization tool's user interface to allow artists to specify their preferences. The system may design intuitive and visually appealing controls that are easy to understand and manipulate, enhancing the user experience.

Preference selection may include providing options for artists to select preferences such as genre, mood, tempo, lyrical themes, or specific artists they admire. The system may allow artists to input preferences directly through text input fields or select from predefined lists of options.

Filtering mechanisms may include implementing filtering mechanisms that dynamically adjust visualization outputs based on the selected preferences. The system may enable artists to filter visualizations by genre, mood, or thematic keywords to focus on specific subsets of the data that match their preferences.

Genre tagging and metadata may include incorporating genre tagging and metadata annotation into the dataset to facilitate genre-based filtering and recommendation. The system may ensure that each song or lyric is associated with relevant genre labels or descriptors that artists can use to filter recommendations.

Mood and emotion analysis may include integrating sentiment analysis algorithms to analyze mood and emotional content in song lyrics and provide artists with options to filter recommendations based on desired mood or emotional tone. The system may allow artists to adjust mood sliders or select mood categories (e.g., happy, sad, energetic) to refine recommendation results.

Thematic keyword search may include enabling artists to search for specific lyrical themes or keywords within the visualization tool, filtering recommendations based on thematic relevance. The system may implement autocomplete or suggestion features to assist artists in identifying relevant thematic keywords and concepts.

Personalization profiles may include providing artists with the option to create personalized profiles or settings within the visualization tool, where they can save their preferences and settings for future use. The system may allow artists to customize default settings, theme colors, and visualization layouts to align with their personal preferences and workflow.

Feedback mechanisms may include incorporating feedback mechanisms that allow artists to provide input and adjust recommendations based on their preferences and feedback. The system may enable artists to rate and provide feedback on recommended songs, lyrics, or themes, informing future recommendation generation.

### Implementation Details

In embodiments, implementation details include backend integration, data mapping and visualization updates, error handling and validation, and persistence and saving preferences.

Backend integration may include developing backend functionality to process user-selected preferences and dynamically adjust data queries and filtering operations based on the selected options. The system may ensure seamless integration between the frontend visualization interface and backend data processing logic to enable real-time updates and interaction.

Data mapping and visualization updates may include mapping user-selected preferences to relevant data attributes and parameters within the visualization tool, triggering updates and recalculations of visualizations based on the selected options. The system may implement event listeners and callbacks to detect changes in user preferences and trigger visualization updates accordingly.

Error handling and validation may include implementing error handling mechanisms to validate user input and handle edge cases or invalid selections gracefully. The system may provide informative error messages or prompts to guide users in correcting their selections and ensuring smooth interaction with the customization options.

Persistence and saving preferences may include enabling the persistence of user preferences and settings across sessions, allowing artists to save their customization options and retrieve them upon returning to the visualization tool. The system may implement storage mechanisms such as cookies, local storage, or user accounts to store and retrieve personalized settings securely. The system may provide real-time feedback and suggestions as artists write, helping them overcome writer's block and explore new creative directions.

### Real-Time Feedback and Suggestions Implementation

In embodiments, real-time feedback and suggestions implementation includes text analysis and monitoring, dynamic visualization updates, inline suggestions and alerts, sentiment analysis and mood tracking, thematic consistency checks, genre-specific recommendations, collaborative writing features, and engagement and gamification.

Text analysis and monitoring may include continuously analyzing the artist's writing in real-time using natural language processing (NLP) techniques to detect patterns, themes, and emotional tone. The system may monitor the text input for lyrical themes, sentiment, and stylistic elements to provide context-aware feedback and suggestions.

Dynamic visualization updates may include dynamically updating visualizations and recommendations based on the artist's input and writing context, reflecting changes in mood, theme, or lyrical content. The system may use reactive programming techniques or WebSocket connections to enable real-time updates of visualization outputs as the artist writes.

Inline suggestions and alerts may include providing inline suggestions and alerts within the writing interface to highlight potential improvements, suggest alternative phrases or words, or alert the artist to thematic inconsistencies. The system may display tooltips or pop-up notifications that offer helpful hints, prompts, or creative prompts based on the current writing context.

Sentiment analysis and mood tracking may include continuously tracking changes in sentiment and mood in the artist's writing, providing feedback on emotional consistency and coherence. The system may highlight shifts in mood or tone and offer suggestions to maintain thematic continuity or explore new creative directions based on detected emotional shifts.

Thematic consistency checks may include performing thematic consistency checks by comparing the artist's current writing with previously established themes, motifs, or genre conventions. The system may alert the artist to deviations from established themes and provide guidance on maintaining thematic coherence or experimenting with thematic variations.

Genre-specific recommendations may include tailoring recommendations and suggestions to the artist's specified genre preferences, providing genre-specific prompts, chord progressions, or lyrical themes that align with their creative vision. The system may dynamically adjust visualization outputs and recommendation generation algorithms to focus on genre-appropriate patterns and motifs.

Collaborative writing features may include enabling collaborative writing features that allow artists to collaborate with other musicians, songwriters, or AI assistants in real-time. The system may facilitate real-time collaboration and feedback exchange, enabling artists to brainstorm ideas, share insights, and co-create songs seamlessly.

Engagement and gamification may include incorporating engagement features such as progress trackers, achievement badges, or creative challenges to motivate and inspire artists during the writing process. The system may reward creative exploration and experimentation with positive reinforcement and recognition within the writing interface.

### Implementation Details

### Backend Integration and Analysis Pipelines

Develop backend services and analysis pipelines to process real-time text input, perform NLP tasks, and generate dynamic feedback and suggestions.

Implement efficient algorithms and data structures to enable fast and responsive analysis of text data and generation of feedback insights.

### User Interface Interactivity

Enhance user interface interactivity with features such as autocomplete suggestions, live previews, and interactive feedback widgets.

Enable seamless integration between the writing interface and visualization tools, allowing artists to access real-time feedback without interrupting their creative flow.

### Feedback Aggregation and Summarization

Aggregate real-time feedback insights from multiple sources, including NLP analysis, visualization outputs, and collaborative contributions.

Summarize and present feedback in a concise and actionable format, highlighting key insights and recommendations to guide the artist's creative process effectively.

### User Preference Customization

Allow artists to customize feedback preferences and sensitivity levels to align with their personal writing style and preferences.

Provide options to adjust the frequency and granularity of feedback prompts, allowing artists to tailor the feedback experience to their individual needs.

### Feedback Logging and Analysis

Log and analyze feedback interactions and responses to iteratively improve the effectiveness and relevance of real-time feedback mechanisms.

Collect user feedback and usage data to refine feedback algorithms, optimize recommendation generation, and enhance the overall user experience.

Integrate with existing songwriting software and digital audio workstations (DAWs) for seamless workflow integration.

Continuously update and refine the AI models based on user feedback and evolving trends in music composition.

Offer interactive features such as exploration of similar artists' styles or collaborative songwriting sessions with other users.

Ensure privacy and security of user data by implementing robust encryption and data anonymization techniques.

### Sentiment Analysis and Emotional Context Recognition

Develop sentiment analysis algorithms that analyze lyrical content to identify emotions expressed in the lyrics, such as happiness, sadness, love, or anger.

Incorporate emotional context recognition to understand the overall mood and atmosphere conveyed by the music, including tempo, instrumentation, and arrangement.

Utilize machine learning models trained on emotional lexicons and music theory principles to accurately interpret the emotional content of songs.

Provide visualizations or mood boards that depict the emotional journey of a song, helping artists convey specific moods and messages effectively.

Offer mood-based recommendation systems that suggest musical elements (e.g., chords, melodies, instrumentation) aligned with the desired emotional context.

Enable artists to experiment with different emotional expressions in their songs through interactive interfaces and real-time feedback.

Implement sentiment-aware lyric generators that suggest lyrical phrases and themes consistent with the desired emotional tone.

Collaborate with psychologists, music theorists, and industry professionals to develop comprehensive emotional analysis frameworks tailored to songwriting needs.

Integrate sentiment analysis and emotional context recognition seamlessly into the songwriting process, allowing artists to focus on creative expression.

Continuously update and improve the sentiment analysis models based on user feedback and advances in natural language processing research.

### Customizable Templates and Collaborative Features

Develop a library of customizable songwriting templates covering various genres, song structures, and themes, providing artists with starting points for their compositions.

Allow artists to personalize templates by adjusting parameters such as tempo, key, instrumentation, and lyrical content to suit their creative vision.

Implement collaborative features that enable real-time collaboration among multiple artists, allowing them to co-write songs remotely and share ideas seamlessly.

Provide version control and revision history features to track changes and updates made during collaborative songwriting sessions.

Enable cloud-based storage and synchronization of songwriting projects, ensuring accessibility and continuity across devices and locations.

Integrate with popular collaboration platforms and communication tools to facilitate communication and coordination among collaborators.

Offer feedback and review mechanisms within the platform, allowing collaborators to provide constructive feedback on each other's contributions.

Support flexible licensing and royalty management options for collaborative projects, ensuring fair compensation for all contributors.

Develop user-friendly interfaces that promote intuitive collaboration and streamline the creative workflow for artists working together remotely.

Continuously update and enhance the collaborative features based on user feedback and emerging trends in remote collaboration tools.

Method and Process Allowing Access and Use of Selected Music and Content by Users of Artificial Intelligent based Large Language Models (AI-LLM's) without the Selected Music and Content being Trained on the AI based Large Language Model.

Musicians that have created original musical recordings prior to the creation of Artificial Intelligent systems may not want all of their music trained by these systems. However, they may find value in having users of the AI based LLM's access some of their music, or specific parts of their music. This could be lyrics, melodies, harmonies, audio, drumbeats, guitar riffs, piano solos and others. Complementary additions could be videos, artist likeness, band or artist artwork, and other related intellectual property assets.

The following process and methods outlines how musicians, recording studios and other representatives of the artists can ensure that AI based LLM systems can access their specific and approved music and or related intellectual property without having all of their music be trained on or by the Artificial Intelligent Large Language Model and still allow users of the AI based LLM access to the artists' selected materials.

### Large Language Models

Working seamlessly with large language models (LLMs) to integrate existing music and or content selected by the artist or their representatives without having that specific music or content be trained on the AI based LLM directly is outlined in the following steps.

Digitize Existing Music: Convert all selected analog and or digital musical and media recordings into an “only” digital format that can be processed by computers and computer networks. This may involve converting analog recordings to digital audio files and ensuring that all digital recordings are in compatible formats.

Prepare Metadata: Along with digitizing the selected music and content; prepare metadata for each selected composition. Metadata can include existing and preferred information such as the title of the composition, genre, tempo, key signature, mood, instrumentation, and any other relevant details that describe the musical content.

Curate the Defined Musical and Related Media Library: Organize all selected digitized music and metadata into a well-curated library. This library will serve as the repository from which users of the Large Language Models (AI-LLM) access the non-trained music and media.

Integrate with the Large Language Model (LLM): Identify a suitable platform or framework that supports integration with AI based Large Language Models (LLMs). These can be platforms like OpenAI's API, or Hugging Face's Transformers library or others. Use the selected platform's API or libraries to develop an interface that allows users of the AI based LLM to access the selected music and media library alongside the LLM's capabilities. Ensure that designed and developed interfaces provide seamless integration, allowing users to search, browse, and select identified music compositions and related media from the identified library while also interacting with the LLM for generating or modifying selected parts of the chosen music and materials.

Develop Compatibility: Ensure that the selected music library and any related materials like lyrics, voice, images, videos and other related materials can interface and be compatible with the input and output formats expected by the LLM. This can include the conversion of audio files to formats supported by selected LLM's and defining interfaces for communication between the defined system and the LLM platform.

User Access and Permissions: Implement mechanisms for user access and permissions to control who can access the un-trained music library and how they can interact with it. Artists and representatives should consider the development of options for public access, restricted access, and user authentication to ensure privacy and security of the untrained music and content.

Testing and Validation of Untrained Selected Content: The interactivity with the LLM should be thoroughly tested to ensure that it functions as intended by the artist, representative or owner of the untrained music, media and other related but selected intellectual property assets. Owners of the content should test various use cases, including searching for the selected untrained music and for combining the selected untrained music with other approved AI-generated categories, functions, capabilities, compositions and testing the modifying approved un-trained music based on the owner's original decisions but with the AI-LLM user's specific preferences.

User Documentation and Support: The Creator, Owner and Representative of the selected Un-Trained Music and Content will need to provide comprehensive documentation and support resources for those AI-LLM users who want to access and use the creators selected un-trained music and related content library with the LLM. This may include tutorials, FAQs, and troubleshooting guides to help users make the most of the content and enabling system.

Feedback and Iteration: In order to make the use of untrained music and content, the platform should be able to gather feedback from users and iterate on your integration based on their input. The platform should continuously improve the user experience, address any issues or limitations, and explore features or enhancements to enhance the value of the selected “untrained” music and related content media library within the approved LLM ecosystem.

This method and process allows an untrained music and content library with large language models, allowing users of the AI based LLM to access and use untrained compositions and media alongside other AI-generated music compositions.

Collaborative Music Platforms Integrating AI Systems with Human Musicians and Other 3^{rd} Party Artificial Intelligent Solutions

Developing collaborative platforms for the music industry that integrate AI systems with human musicians and other AI entities involves several key components and functionalities. The following is a detailed overview.

### User Interface and Experience

The collaborative platform should feature an intuitive user interface that allows musicians and AI systems to interact seamlessly. It should support various input methods, including MIDI controllers, keyboards, voice commands, and graphical interfaces, to accommodate different preferences and workflows. The platform should prioritize user experience, providing tools and features that enhance creativity and productivity for both humans and AI entities.

### Integration of AI Systems

The platform 100 can integrate multiple AI systems, including generative models (such as GANs or Variational Autoencoders), music recommendation algorithms, and music analysis tools.

These AI systems contribute to different stages of the music creation process, from generating musical ideas to providing feedback and analysis on compositions.

### Real-Time Feedback Mechanisms

The platform incorporates real-time feedback mechanisms that enable continuous interaction between human musicians and AI systems. As musicians create and edit music compositions, AI algorithms provide immediate feedback on aspects such as harmony, melody, rhythm, and arrangement. This feedback can be presented through visualizations, audio previews, or textual annotations, allowing musicians to make informed decisions during the creative process.

### Version Control and Collaboration Features

The platform 100 can include version control capabilities that track changes made to music compositions over time. Musicians can create multiple versions or branches of a composition, experiment with different ideas, and compare revisions side by side.

Collaboration features enable multiple users, including musicians, producers, and AI systems, to work together on the same composition simultaneously. Users can share compositions, comment on specific sections, and collaborate in real-time or asynchronously, regardless of their physical location.

Seamless Integration between Human and AI Creativity

The platform fosters seamless integration between human creativity and AI-generated content by providing tools for co-creation and mutual inspiration. Musicians can interact with AI systems to generate musical ideas, explore new genres, or overcome creative blocks.

AI algorithms analyze existing compositions to suggest variations, improvements, or complementary elements, enhancing the creative process without replacing human input.

The platform empowers users to leverage the strengths of both human intuition and AI computational power, resulting in innovative and unique music compositions.

### Customization and Personalization

The platform allows users to customize and personalize their experience based on individual preferences and requirements. Musicians can configure AI algorithms according to desired styles, influences, or constraints, tailoring the output to suit their artistic vision. AI models may be trained on specific datasets or fine-tuned based on user feedback, improving their ability to generate relevant and high-quality music content.

Overall, collaborative platforms for the music industry enable human musicians and AI systems to interact and co-create music compositions in a seamless and integrated manner. By incorporating real-time feedback mechanisms, version control, and collaborative editing features, these platforms facilitate creativity, experimentation, and innovation, while respecting the unique contributions of both humans and AI entities.

In embodiments, processes, systems and methods disclosed herein include integrating interactive evolutionary algorithms (IEAS) within non-AI created musical recordings and AI generated music from large language models.

By following the below defined process and method, a system can be created that integrates Interactive Evolutionary Algorithms (IEAs) within both existing non-AI created musical content and new AI-generated music and content thus ultimately enabling users to explore diverse musical styles and preferences through the combination of Human-AI collaboration.

Goal Definition: To initiate the system, users are required to start by defining the goals of the planned system. For example, what kind of music or related content does a user or listener want to generate? What are the characteristics or styles that are wanted to explore? These objectives shall guide the design and implementation of this system.

### Data Collection and Preparation

Existing Musical Recordings: Gather a diverse dataset of existing musical recordings across various genres and styles. Ensure that the dataset is well-curated and representative of different musical characteristics.

AI-Generated Music: Utilize pre-trained musical AI models or train your own models using large language models and musical AI software. Generate a diverse set of AI-generated music samples to serve as the starting point for evolution.

Feature Extraction: Extract relevant features from both the existing musical recordings and AI-generated music. These features may include melody, harmony, rhythm, tempo, timbre, etc. Feature extraction can be done using signal processing techniques or pre-trained models.

### Interactive Evolutionary Algorithm Implementation

Choose an appropriate evolutionary algorithm for your system, such as Genetic Algorithms, Genetic Programming, or Evolution Strategies. Design the genotype representation for the music, which could include parameters representing musical features. Implement the fitness function, which evaluates how well a generated piece of music satisfies user preferences. This function should take user feedback into account. Set up the evolutionary loop where users interact with the platform by providing feedback on generated music, influencing the evolution process towards desirable outcomes.

### User Interface Development

Develop a user-friendly interface where users can interact with the platform. The interface should allow users to listen to music samples, provide feedback, and explore the evolutionary process. Incorporate features for users to rate or rank music samples based on their preferences. This feedback will be crucial for guiding the evolution.

### Integration of Existing Recordings and AI-Generated Music

Combine the existing musical recordings and AI-generated music samples into a unified dataset for the evolutionary process. Ensure that the evolutionary algorithm can handle the mixed dataset and evolve music compositions that incorporate elements from both sources.

### Feedback Mechanism

Implement a mechanism for collecting and processing user feedback. This could involve rating music samples, by providing textual feedback, or using more advanced methods such as preference learning. Update the evolutionary process based on user feedback to iteratively improve the quality of generated music.

### Evaluation and Refinement

Continuously evaluate the performance of the platform based on user satisfaction and the quality of generated music. Refine the platform based on feedback and iterate on its design and implementation to enhance its effectiveness and usability.

### Deployment and Testing

Deploying the platform for real-world usage can permit users to interact with it and provide feedback. In doing so, thorough testing can be conducted to ensure the stability, scalability, and performance of the platform under various conditions.

### Maintenance and Updates

Regularly maintain and update the platform to address user feedback, fix bugs, and incorporate improvements in AI technology and musical understanding.

### Generative Adversarial Networks (GANs) for Music

GANs consist of two neural networks, a generator and a discriminator, trained in opposition to each other. In the context of music, the generator creates new musical content, while the discriminator evaluates its authenticity.

This adversarial process encourages the generator to produce increasingly realistic and creative compositions.

Generative Adversarial Networks (GANs) for music operate on the same principles as GANs in other domains but are tailored to generate musical content. Further below is a detailed overview of how the GAN system works for music, including both the generator and the discriminator.

### Generator Overview

The generator in a music GAN is responsible for creating new musical content. It typically takes random noise or seed inputs as its starting point and generates sequences of musical data. The input to the generator could be in the form of MIDI data, audio waveforms, or symbolic representations of music (such as piano rolls).

The generator is composed of neural network layers, such as recurrent neural networks (RNNs), long short-term memory networks (LSTMs), or transformers, which learn to capture the temporal dependencies and structure of music.

During training, the generator produces music samples based on the random noise inputs. Initially, these samples are random and meaningless, but as training progresses, the generator learns to generate increasingly coherent and realistic musical sequences.

### Discriminator Overview

The discriminator in a music GAN is responsible for distinguishing between real music data and generated music data. It learns to differentiate between genuine musical compositions and those created by the generator.

Similar to the generator, the discriminator is also a neural network, typically a convolutional neural network (CNN) or recurrent neural network (RNN), designed to process music data.

The discriminator receives both real music samples (e.g., from a dataset of existing music) and generated music samples from the generator as input.

During training, the discriminator learns to classify whether the input music sample is real or generated. It provides feedback to the generator on how realistic its generated samples are.

### Overview of Training Process

The training of a music GAN involves a competitive process between the generator and the discriminator.

Initially, the generator produces random music samples, and the discriminator attempts to correctly classify them as fake. As training progresses, the discriminator provides feedback to the generator on how to improve its generated samples to make them more realistic. Meanwhile, the generator adjusts its parameters to produce music that can better fool the discriminator into classifying it as real. This adversarial process continues iteratively, with both networks improving over time. The generator becomes better at creating realistic music, while the discriminator becomes more adept at distinguishing between real and generated music.

### Overview of Loss Functions

The training objective of the GAN is typically defined by two loss functions: one for the generator and one for the discriminator. The generator aims to minimize the discriminator's ability to differentiate between real and generated music, so its loss function encourages it to produce music that the discriminator classifies as real. Conversely, the discriminator aims to correctly classify real and generated music, so its loss function penalizes misclassifications.

The overall training process seeks to find an equilibrium where the generator produces music that is indistinguishable from real music, and the discriminator cannot reliably differentiate between real and generated samples.

In summary, GANs for music consist of a generator that creates new musical content and a discriminator that evaluates the authenticity of the generated music. Through an adversarial training process, the generator learns to produce increasingly realistic and creative compositions, while the discriminator learns to distinguish between real and generated music. This iterative process results in the generation of high-quality and diverse musical outputs.

In embodiments, methods and processes disclosed herein allow for access and use of selected music and content by users of artificial intelligent based large language models (AI-LLM's) without the selected music and content being trained on the AI based large language model.

Musicians that have created original musical recordings prior to the creation of Artificial Intelligent systems may not want all of their music trained by these systems. However, they may find value in having users of the AI based LLM's access some of their music, or specific parts of their music. This could be lyrics, melodies, harmonies, audio, drumbeats, guitar riffs, piano solos and others. Complementary additions could be videos, artist likeness, band or artist artwork, and other related intellectual property assets.

The following process and methods outlines how musicians, recording studios and other representatives of the artists can ensure that AI based LLM systems can access their specific and approved music and or related intellectual property without having all of their music be trained on or by the Artificial Intelligent Large Language Model and still allow users of the AI based LLM access to the artists' selected materials.

### Large Language Models

Working seamlessly with large language models (LLMs) to integrate existing music and or content selected by the artist or their representatives without having that specific music or content be trained on the AI based LLM directly is outlined in the following steps.

Digitize Existing Music: Convert all selected analog and or digital musical and media recordings into an “only” digital format that can be processed by computers and computer networks. This may involve converting analog recordings to digital audio files and ensuring that all digital recordings are in compatible formats.

Prepare Metadata: Along with digitizing the selected music and content; prepare metadata for each selected composition. Metadata can include existing and preferred information such as the title of the composition, genre, tempo, key signature, mood, instrumentation, and any other relevant details that describe the musical content.

Curate the Defined Musical and Related Media Library: Organize all selected digitized music and metadata into a well-curated library. This library will serve as the repository from which users of the Large Language Models (AI-LLM) access the non-trained music and media.

Integrate with the Large Language Model (LLM): Identify a suitable platform or framework that supports integration with AI based Large Language Models (LLMs). These can be platforms like OpenAI's API, or Hugging Face's Transformers library or others. Use the selected platform's API or libraries to develop an interface that allows users of the AI based LLM to access the selected music and media library alongside the LLM's capabilities. Ensure that designed and developed interfaces provide seamless integration, allowing users to search, browse, and select identified music compositions and related media from the identified library while also interacting with the LLM for generating or modifying selected parts of the chosen music and materials.

Develop Compatibility: Ensure that the selected music library and any related materials like lyrics, voice, images, videos and other related materials can interface and be compatible with the input and output formats expected by the LLM. This can include the conversion of audio files to formats supported by selected LLM's and defining interfaces for communication between the defined system and the LLM platform.

User Access and Permissions: Implement mechanisms for user access and permissions to control who can access the un-trained music library and how they can interact with it. Artists and representatives should consider the development of options for public access, restricted access, and user authentication to ensure privacy and security of the untrained music and content.

Testing and Validation of Untrained Selected Content: The interactivity with the LLM should be thoroughly tested to ensure that it functions as intended by the artist, representative or owner of the untrained music, media and other related but selected intellectual property assets. Owners of the content should test various use cases, including searching for the selected untrained music and for combining the selected untrained music with other approved AI-generated categories, functions, capabilities, compositions and testing the modifying approved un-trained music based on the owner's original decisions but with the AI-LLM user's specific preferences.

User Documentation and Support: The Creator, Owner and Representative of the selected Un-Trained Music and Content will need to provide comprehensive documentation and support resources for those AI-LLM users who want to access and use the creators selected un-trained music and related content library with the LLM. This may include tutorials, FAQs, and troubleshooting guides to help users make the most of the content and enabling system.

Feedback and Iteration: In order to make the use of untrained music and content, the platform should be able to gather feedback from users and iterate on your integration based on their input. The platform should continuously improve the user experience, address any issues or limitations, and explore features or enhancements to enhance the value of the selected “untrained” music and related content media library within the approved LLM ecosystem.

This method and process allows an untrained music and content library with large language models, allowing users of the AI based LLM to access and use untrained compositions and media alongside other AI-generated music compositions.

In embodiments, media plugins disclosed herein can be deployed for licensing of content, delivery, validation payment and enabling of copyright media and AI generated content via large language models on social media platforms, downloaded software and websites.

A method for a media content delivery, validation and licensing (CDVL) plugin for enabling licensed copyright media content and AI generated content created through Large Lange Models with the content delivered, integrated and enabled via a software plugin into social media and other software platforms residing on mobile and computer networks.

The CDVL integrates with application programming interfaces (APIs) of networked social media platforms, downloaded software, and other websites and servers. The platforms and downloadable software operate on individual computers and mobile devices.

The CDVL allows for either a single or multiple payment options to license for use of media, or a multiple payment subscription can be obtained allowing licensing and payment schemes of various types. The license subscription or one-time payment can be from the entire platform owner (i.e., TikTok, Facebook, Instagram, etc.) or could be paid by individual users of the platforms for their own social media. Options for payment enhancement could be made to allow social media users to enable the content to be seen or heard for all, some or select followers.

The CDVL allows those who have a validated license to utilize intellectual property copyrights of media companies and/or the artists who created the media content. However, the media companies have control over the licensed content and can stop the licenses at any time if terms and conditions are not met.

The CDVL executes a web crawler for allowing, indexing, inserting licenses, confirming licenses, re-validating licenses, validating subscriptions, enabling distribution of media, removing access to media, enabling cancellation of the license, enabling payment of the license from one or more platforms via the software CDVL plugin.

The plugin is supported by a media management software system that is operated from a location determined by the media company whereby analytics of the system, management of licenses, uploading and downloading of media can be managed and identification of activities is reviewed.

### Copyright Licensing Bot

The platform includes the creation of AI-generated music, derivative works and how artists and music labels receive requests and provide approvals to users of large language model (LLM) artificial intelligent engines that want to use the artists voice, music, songs, lyrics, melodies, other derivative works, videos, images, likeness, among other attributes.

In the simplest of terms, LLM's are next word prediction engines that use numerous methods and processes including software analytics including data scoring, real time aggregation, automated data modeling, data predictions, model tests, validation, and re-validation, among other methods and processes.

Along with OpenAI Chat GPT-3 and 4 LLM, popular large language models also include open models such as Google's LaMDA, Anthropic Claude 2, and PaLM LLM which is the basis for Bard, Hugging Face's BLOOM and XLM-RoBERTa, Nvidia's NeMO LLM, XLNet, Cohere and GLM-130B among many others in development.

It will be appreciated in light of the disclosure that rights holders including labels, artists and creators are faced with significant risks of their intellectual property, copyrighted materials, images, videos and other content materials of being misused. This risk is increased 1000-fold by the development and adoption of Large Language Models that can create content based on publicly available representations of a creator's material.

Because of this, there is an imperative that a solution be implemented that balances the requirements of the needs of artists and music labels, as well as the rapidly growing number of AI engines that can create derivative works.

There are many real financial, operational, reputational, existence risks to the artists, music labels and others due to AI generated content; the artist's and music labels understand that AI technologies are moving very fast and that they must also work very quickly to identify solutions that meet these challenges head-on while providing artists, labels, publishers and other stakeholders in the music industry with solutions that protect themselves, their business and their future.

The systems and methods disclosed herein address the key problems that will quickly arise within the marketplace. It will be imperative that artists, music labels and potentially others provide strict guidance and requirements to a user who is making a request to use the artists' voice, songs, music, video's, images or a combination thereof through a large language model AI engine to create a derivative work.

With the growth of Large Language Model AI technologies in the music industry and the expectation of hundreds of thousands of requests by users to utilize an artist's voice, music, likeness, or similar in rapid succession day-after-day, week-after-week, year-after-year; it will be impossible for an artist or their representative to review these requests one by one and make an approval or disapproval. Additionally, since the majority of user requests will undoubtedly be different, it will not be possible to use standard database solutions to make a determination.

Considering these challenges, the following outlines an improvement in the field of AI-generated music so that artists and music labels can approve or disapprove large quantities of incoming requests by users and AI engines quickly, efficiently and effectively.

These improvements will aim to address the issues associated with what an AI engine and requesting user can or cannot do with the artist's voice, music, songs, lyrics, publications, images, videos, and/or other copyrighted materials.

These improvements will solve a major challenge in this nascent LLM AI-music industry ensuring that rights holders are in control of their voice, music, songs and related intellectual property assets. It will also create a pathway for the industry to grow and ensure incentives for all parties to utilize such a process and method are aligned.

In embodiments, a chatbot 190 interacts with potential licensees that are requesting to use the intellectual property of an artist where the intellectual property assets are copyrights and can include trademarks of the artist consisting of songs, music, books, images, video, written and published music and lyrics and other content owned by creators, artists, music labels and others.

In embodiments, a chatbot 190 interacts with potential licensees who are wanting to obtain access to an artist's intellectual property including their voice, songs, images, books and other copyrighted content owned by the artist.

In embodiments, a chatbot 190 is an “agent” or “plugin” to existing or new large language model (LLM) artificial intelligent platforms such as ChatGPT, Bard, etc. to provide users with the ability to license approved content and create approved derivative works.

In embodiments, a chatbot 190 enables the user to create an account on the licensing platform that allows users to come back over and over again to purchase from the rights holders and obtain approval to obtain licenses for various artists voices, songs, music, images and other attributes from the catalog of copyrighted material and content.

In embodiments, a chatbot 190 questions the potential licensee on a number of usage attributes to identify both the appropriate licensing models and to confirm that the proposed usage of the content is aligned with the artist's principles and overall requirements that need to be met before their material shall be licensed and used in a derivative work.

In embodiments, a chatbot 190 can use audio, visual and text interfaces to gather information from the user and their usage that may include, but is not limited to: Username, Billing and Payment Information, Usage Scenarios, Timeframe of Usage, Commercial Model of Usage, Non-Commercial Model of Usage, Country, State, City of Usage, Other Artists included in any Composite Works, Derivative Works ownership requirements, among others.

In embodiments, a chatbot 190 will have information at its disposal from a variety of open-source and proprietary data sources, including but not limited to major music labels, music catalog owners, and creators directly called “Background Information”.

Based on information gathered from the conversation with the user, and with acquired Background Information a risk profile and proposed licensing model will be proposed to the user.

In embodiments, the risk profile will be determined based on the information gathered and will be a determinant for the need of secondary IP scanning and diligence by a 3rd party.

High risk IP assessments where a determination cannot be made by the agent will be passed to a 3rd party for human assessment. Low risk and non-commercial licensing will be conducted in the chat interface.

In embodiments, the final products and IP delivery will be digitally watermarked to aid in license and payment compliance, tracking and ongoing payments.

In embodiments, the chatbot 190 will be designed to plug into all major LLM providers and enable broad capabilities for the platform to license materials at the point of use for LLM AI users.

In embodiments, the chatbot 190 will have the ability to converse with a User in the voice of the Artist in which the User has interest. The back and forth chatbot interview and discussion would sound like a discussion between the Artist and the User. Avatar and text capabilities are also available to support the audio interview.

In embodiments, the chatbot 190 will have the ability to switch voices and personalities for select needs within the discussions, interviews and ongoing discussions that come up later in time. This can include billing and payment information among other support requirements.

In embodiments, the chatbot 190 can enable the use of existing copyrighted materials to be used to create a derivative song, video, music, book or other output; but before the derivative output file is officially delivered to the user for use in the limited application; the Chatbot can enable communication with a private computer system whereby a new derivative copyright is registered or filed and registered at the USPTO electronically prior to the final delivery of the output file.

The derivative copyright may be registered in the name of the existing rights holders. Depending on the independent creativity contribution to the final output file by the User of the LLM AI engine; the user may be allowed to receive a derivative copyright that will be based on very specific creative factors and criteria created and approved electronically by pre-identified rules by one, some or a combination of the artist, music label, copyright attorneys and others.

After the User receives a license (limited use or otherwise) to the derivative output file whereby it is executed electronically by all necessary signatory parties; a copyright for the derivative works will also be registered and issued to existing rights holders. In embodiments, the existing rights holders will have the right to use the copyrighted material in those areas outlined in the initial agreements for use of the platform.

In embodiments, the copyright licensing bot has the ability to directly interface with Users whereby derivative works can be created directly from the platform without Users having to interact with an LLM-AI engine. The cloud server maintaining all IP assets owned by rights holders can be connected directly to an AI generated chatbot outside of external LLM-AI engines whereby the same process for creating derivative works can be utilized.

Platform Enabling Dynamic Pricing with Packaging Models to Optimize Revenue Generation in the Music Industry while Utilizing AI Driven Pricing Algorithms to Adjust Pricing in Real-Time Based on Demand, Seasonality and Market Conditions

By implementing the detailed methods, processes and techniques into a technology platform; music industry stakeholders can effectively leverage dynamic pricing and packaging models to optimize revenue generation, offer personalized subscription plans, create intellectual property bundles, and premium content packages, and utilize AI-driven pricing algorithms to adjust pricing in real-time based on demand, seasonality, and market conditions. These tools can be shown to increase revenue opportunities for the music industry overall, specific companies, partners, artists and others.

### Implement Dynamic Pricing and Packaging Models

In embodiments, implementing dynamic pricing and packaging models includes data collection and analysis, segmentation and targeting, dynamic pricing strategies, packaging and bundling, promotions and discounts, subscription models, dynamic upselling and cross-selling, agile pricing experimentation, real-time monitoring and optimization, and compliance and ethics.

Data collection and analysis may include collecting comprehensive data on consumer behavior, including purchasing patterns, streaming preferences, and demographic information. The system may utilize advanced analytics techniques such as machine learning and predictive modeling to analyze historical sales data and identify trends and patterns. The system may incorporate external factors such as market competition, economic conditions, and industry trends into the analysis.

Segmentation and targeting may include segmenting customers into distinct groups based on factors such as music genre preferences, listening habits, geographic location, and willingness to pay. The system may use clustering algorithms to identify homogeneous customer segments with similar characteristics and preferences. The system may develop targeted marketing strategies and pricing tactics tailored to each customer segment to maximize revenue.

Dynamic pricing strategies may include implementing dynamic pricing algorithms that adjust prices in real-time based on factors such as demand, supply, competitor pricing, and customer segmentation. The system may utilize price optimization techniques such as revenue management, price elasticity modeling, and A/B testing to determine optimal price points for different products and services. The system may monitor and analyze pricing dynamics in the market and make timely adjustments to pricing strategies to maintain competitiveness and maximize revenue.

Packaging and bundling may include creating flexible packaging options and bundles that combine multiple products or services at discounted prices. The system may offer tiered pricing plans with varying levels of features, benefits, and access to exclusive content to appeal to different customer segments. The system may use data-driven insights to identify complementary products or services that can be bundled together to enhance value and increase customer satisfaction.

Promotions and discounts may include designing targeted promotional campaigns and discount offers to stimulate demand and drive sales during specific time periods or events. The system may use dynamic pricing algorithms to determine the timing, duration, and magnitude of discounts based on customer segmentation, inventory levels, and market conditions. The system may implement personalized discounting strategies that offer tailored discounts to individual customers based on their purchase history, loyalty status, and engagement level.

Subscription models may include offering subscription-based pricing models that provide unlimited access to music content for a fixed recurring fee. The system may customize subscription plans based on customer preferences, such as ad-free streaming, offline listening, high-definition audio quality, and exclusive content access.

The system may use predictive analytics to forecast subscription chum rates and proactively implement retention strategies to reduce customer attrition.

Dynamic upselling and cross-selling may include implementing dynamic upselling and cross-selling strategies to encourage customers to upgrade to higher-priced subscription tiers or purchase additional products and services. The system may analyze customer usage patterns and behavior to identify opportunities for upselling and cross-selling relevant products or features. The system may personalize upsell and cross-sell recommendations based on individual customer preferences and past purchase history.

Agile pricing experimentation may include conducting pricing experiments and A/B tests to evaluate the impact of different pricing strategies on revenue generation and customer behavior. The system may test variations in pricing structures, discount levels, and packaging options to identify the most effective pricing configurations. The system may use statistical analysis techniques to measure the statistical significance of pricing experiments and make data-driven decisions on pricing adjustments.

Real-time monitoring and optimization may include implementing real-time monitoring systems to track key performance metrics such as sales revenue, customer acquisition, retention rates, and profit margins. The system may use dashboard analytics and reporting tools to visualize performance metrics and identify areas for improvement or optimization. The system may continuously monitor market trends, competitor pricing strategies, and customer feedback to adapt pricing and packaging models accordingly.

Compliance and ethics may include ensuring compliance with regulatory requirements and industry standards for pricing transparency, fairness, and consumer protection. The system may implement ethical pricing practices that prioritize customer satisfaction, trust, and long-term relationships over short-term profit maximization.

The system may communicate pricing changes and updates transparently to customers, providing clear explanations and justifications for pricing adjustments.

### Offer Personalized Subscription Plans, Bundles, and Premium Content Packages

In embodiments, offering personalized subscription plans includes data-driven personalization, customizable subscription tiers, exclusive content access, bundle offerings, loyalty rewards and incentives, subscription gifting and sharing, trial periods and free samples, user engagement and feedback, localized and regional offerings, and continuous improvement and innovation.

Data-driven personalization may include collecting and analyzing customer data to understand individual preferences, listening habits, and content consumption patterns. The system may develop personalized recommendation engines that suggest subscription plans, bundles, and premium content packages based on each user's unique interests and preferences. The system may use collaborative filtering, content-based filtering, and hybrid recommendation algorithms to deliver personalized recommendations at scale.

Customizable subscription tiers may include offering customizable subscription tiers that allow users to tailor their plans based on specific features, benefits, and pricing options. The system may provide flexibility for users to mix and match subscription components such as streaming quality, offline downloads, ad-free listening, and access to exclusive content. The system may implement user-friendly interfaces and interactive tools that enable users to adjust subscription settings and preferences easily.

Exclusive content access may include curating exclusive content libraries and premium collections that are available only to subscribers of certain tiers or packages. The system may partner with artists, record labels, and content creators to produce exclusive music releases, live performances, behind-the-scenes footage, and other bonus content for subscribers. The system may create limited-time offers and incentives to encourage users to upgrade to higher-tier subscription plans to access exclusive content.

Bundle offerings may include designing bundled offerings that combine music streaming subscriptions with other related products or services, such as concert tickets, merchandise discounts, or music instrument rentals. The system may collaborate with third-party partners in adjacent industries to create value-added bundles that appeal to a broader audience and drive incremental revenue.

Loyalty rewards and incentives may include implementing loyalty programs and rewards systems that offer incentives and perks to long-term subscribers, such as VIP access to events, early access to new releases, or personalized playlists curated by music experts. The system may use gamification techniques to encourage user engagement and participation in loyalty programs, such as points-based rewards, achievement badges, and social recognition.

Subscription gifting and sharing may include enabling users to gift subscription plans to friends and family members as a personalized and thoughtful gesture. The system may facilitate subscription sharing features that allow users to share their subscription benefits with authorized users, such as family members or household members.

Trial periods and free samples may include offering free trial periods or limited-time promotional offers to allow potential subscribers to experience the benefits of premium subscription plans. The system may provide free samples of premium content or exclusive features to users as a teaser to encourage them to upgrade to full subscription plans.

User engagement and feedback may include soliciting user feedback and preferences through surveys, polls, and user feedback mechanisms to understand customer needs and preferences. The system may use data analytics to analyze user engagement metrics such as listening habits, playlist creation, and content sharing to inform personalized subscription offerings.

Localized and regional offerings may include customizing subscription plans and content offerings to cater to the preferences and cultural tastes of different regions and markets. The system may partner with local artists, music labels, and cultural institutions to curate region-specific playlists, music festivals, and exclusive events for subscribers.

Continuous improvement and innovation may include iterating on subscription offerings based on user feedback, market research, and competitive analysis to stay ahead of evolving customer preferences and industry trends. The system may invest in research and development to innovate new subscription models, pricing strategies, and value propositions that differentiate the service and drive customer loyalty and retention.

### Utilize AI-Driven Pricing Algorithms

In embodiments, utilizing AI-driven pricing algorithms includes data integration and preparation, feature engineering, algorithm selection and training, real-time data processing, demand forecasting, price elasticity modeling, dynamic pricing rules, market segmentation and targeting, price optimization, and continuous monitoring and optimization.

Data integration and preparation may include aggregating diverse datasets including historical sales data, market trends, competitor pricing, and customer behavior data from internal and external sources. The system may clean and preprocess the data to remove outliers, handle missing values, and standardize formats for compatibility with AI algorithms.

Feature engineering may include extracting relevant features from the data such as product attributes, customer demographics, pricing variables, and market indicators. The system may engineer new features and transformations to capture complex relationships and interactions between variables.

Algorithm selection and training may include choosing appropriate AI algorithms for dynamic pricing such as regression models, decision trees, neural networks, reinforcement learning, or genetic algorithms. The system may train the pricing algorithms using historical data and optimize model parameters to minimize prediction errors and maximize revenue.

Real-time data processing may include developing scalable and efficient data pipelines and processing systems to handle real-time data streams and updates. The system may implement streaming data processing frameworks such as Apache Kafka or Apache Flink to ingest, process, and analyze data in near real-time.

Demand forecasting may include using machine learning models to forecast demand for music products and services based on historical sales data, seasonality, and market trends. The system may incorporate advanced time series forecasting techniques such as ARIMA, exponential smoothing, or LSTM networks to predict future demand patterns.

Price elasticity modeling may include estimating price elasticity of demand using statistical regression models to quantify the responsiveness of sales to changes in price. The system may analyze price elasticity coefficients to determine optimal pricing strategies that balance revenue maximization with customer demand sensitivity.

Dynamic pricing rules may include defining dynamic pricing rules and algorithms that adjust prices in real-time based on demand signals, inventory levels, competitor pricing, and customer segmentation. The system may implement rule-based logic or machine learning algorithms to automate pricing decisions and adapt to changing market conditions.

Market segmentation and targeting may include segmenting the market into distinct customer groups based on factors such as demographics, purchasing behavior, and price sensitivity. The system may customize pricing strategies and promotional offers for each customer segment to maximize revenue and profitability.

Price optimization may include optimizing pricing strategies using mathematical optimization techniques such as linear programming, integer programming, or genetic algorithms. The system may define objective functions that maximize revenue, profit margin, or market share subject to constraints such as pricing regulations, capacity constraints, or inventory limits.

Continuous monitoring and optimization may include monitoring key performance indicators (KPIs) such as revenue, profit margin, sales volume, and customer satisfaction to evaluate the effectiveness of dynamic pricing algorithms. The system may implement feedback loops and automated alerts to detect anomalies, deviations from targets, and opportunities for optimization in real-time. The system may continuously refine and improve pricing algorithms based on observed outcomes, user feedback, and changes in market dynamics.

The detailed processes, methods and techniques may be integrated into a technology platform providing music industry stakeholders with the ability to effectively leverage dynamic pricing and packaging models to optimize revenue generation, offer personalized subscription plans, bundles, and premium content packages while utilizing AI-driven pricing algorithms to adjust pricing in real-time based on demand, seasonality, and market conditions.

### Large Language Model (LLM) Agent Copyright Crawler

The systems and methods disclosed herein include the creation of a copyright crawler that is used in conjunction with an AI-generated music-derivative works platform and copyright bot; whereby the copyright bot interfaces in between the derivative works platform and LLM engines which are accessed by Users. The copyright crawler can crawl the internet after licenses are provided to Users who have accessed LLM's to obtain copyright licenses to derivative works created by using LLM's.

Users access large language model (LLM) artificial intelligence engines to use an artist's voice, music, songs, lyrics, melodies, videos, images, likeness among other attributes.

In the simplest of terms, LLM's are next word prediction engines that use numerous methods and processes including software analytics including data scoring, real time aggregation, automated data modeling, data predictions, model tests, validation, and re-validation, among other methods and processes.

Along with OpenAI Chat GPT-3 and 4 LLM, popular large language models also include open models such as Google's LaMDA, Anthropic Claude 2, and PaLM LLM which is the basis for Bard, Hugging Face's BLOOM and XLM-RoBERTa, Nvidia's NeMO LLM, XLNet, Cohere and GLM-130B among others in development.

In embodiments, the systems and methods herein include using artificial intelligence and content “watermarking” to create an AI related copyright crawler that works across the Internet and interacts with Copyrighted Derivative Content created by Users of LLM's.

Today owners of music and other creative works being distributed on the internet are not able to fully capture revenue and appropriately license the usage of these works. Further when these works are transformed into new content using AI and other methods or repurposed into new formats and use cases this problem is compounded.

In embodiments, the systems and methods herein include a copyright crawler that samples content streams from the Internet and other sources to identify potentially unlicensed or mis-licensed content.

In embodiments, the systems and methods herein include a copyright crawler that captures samples of the content streams, and uses a Machine Learning model to detect digital watermarks from images and sounds.

In embodiments, the systems and methods herein include a copyright crawler that detects watermarks and can identify licensed materials and cross reference the material, use case, location data with any intellectual property licenses that are in force.

By way of these examples, determinations can be made and can include material found to be licensed and in compliance with terms; material found to be licensed but not in compliance with terms; materials licensed, but not by the user or content streamer currently identified; material is a derivative or composite work that includes copyright materials and appropriately licensed; material is a derivative or composite work that includes copyright materials and not appropriately licensed, and the like.

In embodiments, the systems and methods herein include a copyright crawler that can identify actions that need to be taken by either a License Bot or by a human based on bot logic. Action can include: LLM Agent intelligently connects with a source of materials and proposes licensing terms; LLM Agent intelligently thanks user for having properly licensed usage; LLM Agent sends one or more cease and desist letters to user or streamer; LLM agent flags the usage for human legal intervention; and the like.

### CONCLUSION

While only a few embodiments of the disclosure have been shown and described, it may be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It may further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionalities may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon may become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art may understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

What is claimed is:

1. A method for developing songwriting suggestions comprising:
analyzing partial compositions to identify musical context and structural patterns;
providing contextually appropriate suggestions for chord progressions based on harmonic analysis;
generating melodic development suggestions that complement existing musical content;
offering lyrical content suggestions that match thematic and emotional requirements;
providing structural arrangement suggestions including verse-chorus organization and bridge sections;
analyzing musical genre conventions to ensure stylistic consistency;
generating instrumentation suggestions based on genre-specific orchestration patterns;
providing real-time creative assistance integrated with digital audio workstations;
maintaining databases of successful musical compositions for reference and inspiration; and
adapting suggestions based on individual artist preferences and historical creative patterns.

2. The method of claim 1, further comprising analyzing tempo and rhythm patterns to ensure musical coherence in suggestions.

3. The method of claim 1, further comprising performing at least one of generating suggestions for vocal harmonies and backing arrangements, or generating alternative versions of suggested content with different emotional tones.

4. The method of claim 1, further comprising providing dynamic range and arrangement suggestions for different song sections.

5. The method of claim 1, further comprising analyzing market trends to suggest commercially viable musical directions.

6. The method of claim 1, further comprising providing real-time collaboration features for multiple artists working on a same composition.

7. The method of claim 1, further comprising performing at least one of analyzing successful song structures within specific genres to inform suggestions, or providing automated arrangement suggestions for different instrumental configurations.

8. The method of claim 1, further comprising performing at least one of generating suggestions for transitions between different song sections, or generating percussion and drum pattern suggestions tailored to specific musical styles.

9. The method of claim 1, further comprising performing at least one of analyzing vocal range requirements and adjusting melodic suggestions accordingly, or analyzing lyrical themes and suggesting complementary musical elements.

10. The method of claim 1, further comprising providing copyright clearance verification for suggested content.

11. The method of claim 1, further comprising performing at least one of generating suggestions for song endings and climactic sections, and generating suggestions for remix and variation opportunities.

12. The method of claim 1, further comprising providing personalized suggestion algorithms based on individual artist preferences.

13. The method of claim 1, further comprising analyzing emotional arc progression within songs to suggest appropriate musical development.

14. The method of claim 1, further comprising providing real-time feedback on commercial viability of suggested directions.

15. A system for developing songwriting suggestions comprising:
a composition analysis module configured to analyze partial compositions and identify musical context;
a chord progression suggestion engine configured to provide harmonically appropriate recommendations;
a melodic development module configured to generate complementary melodic suggestions;
a lyrical content suggestion engine configured to provide thematically appropriate textual content;
a structural arrangement module configured to suggest verse-chorus organization and bridge sections;
a genre analysis module configured to ensure stylistic consistency;
an instrumentation suggestion engine configured to provide orchestration recommendations;
a real-time assistance interface configured to integrate with digital audio workstations;
a musical database configured to store successful compositions for reference; and
one or more processors configured to execute instructions to:
analyze partial compositions;
generate contextually appropriate suggestions;
provide real-time creative assistance;
maintain databases of musical references; and
adapt suggestions based on individual artist preferences.

16. A method for copyright licensing comprising:
interacting with potential licensees through an intelligent chatbot system requesting intellectual property usage rights;
operating as an agent or plugin to existing large language model platforms including ChatGPT and Bard;
questioning users on usage attributes including commercial versus non-commercial models, timeframe requirements, and geographical scope;
determining risk profiles based on gathered information using machine learning algorithms;
escalating high-risk assessments to third parties for human assessment and review;
generating automated licensing proposals based on usage requirements and risk assessment;
maintaining integration with digital watermarking capabilities for compliance monitoring;
processing licensing agreements and generating appropriate documentation;
tracking license usage and ensuring compliance with agreed terms; and
providing real-time licensing status updates to copyright holders and licensees.

17. The method of claim 16, further comprising performing at least one of analyzing historical licensing data to optimize approval decisions, or maintaining audit trails of all licensing decisions and communications.

18. The method of claim 16, further comprising generating customized licensing terms based on specific use case requirements.

19. The method of claim 16, further comprising providing automated renewal notifications for expiring licenses.

20. The method of claim 16, further comprising integrating with payment processing systems for automatic license fee collection.

21. The method of claim 16, further comprising performing at least one of generating reports on licensing activity and revenue generation, or analyzing market conditions to suggest competitive licensing rates.

22. The method of claim 16, further comprising providing API access for third-party applications to request licensing services.

23. The method of claim 16, further comprising generating cease and desist communications for unauthorized usage.

24. The method of claim 16, further comprising performing at least one of providing multi-language support for international licensing negotiations, or providing automated dispute resolution mechanisms for licensing conflicts.

25. The method of claim 16, further comprising performing at least one of maintaining databases of licensing precedents and comparable agreements, or generating licensing recommendations based on content similarity analysis.

26. The method of claim 16, further comprising performing at least one of analyzing usage patterns to suggest licensing optimization opportunities, or generating compliance monitoring reports for licensed content usage.

27. The method of claim 16, further comprising providing real-time licensing availability information for content catalogs.

28. The method of claim 16, further comprising maintaining integration with content distribution platforms for licensing enforcement.

29. The method of claim 16, further comprising generating licensing performance analytics and success metrics.

30. A system for copyright licensing comprising:
an intelligent chatbot system configured to interact with potential licensees requesting intellectual property usage rights;
a plugin interface configured to operate with existing large language model platforms;
a user questionnaire module configured to collect usage attribute information;
a risk assessment engine configured to determine risk profiles using machine learning algorithms;
an escalation system configured to route high-risk assessments to human review;
a proposal generation module configured to create automated licensing proposals;
a digital watermarking integration module configured to ensure compliance monitoring;
a licensing agreement processing system configured to generate appropriate documentation;
a usage tracking module configured to monitor license compliance; and
one or more processors configured to execute instructions to:
interact with potential licensees through automated systems;
collect usage requirement information;
assess risk profiles and generate licensing proposals;
process licensing agreements and documentation;
track license usage and ensure compliance; and
provide real-time status updates to stakeholders.
